(19) United States
(12) Patent Application Publication
(10) Pub. No.: US 2026/0360323 A1
(43) Pub. Date: Nov. 12, 2026

(54) Image Display Processing Method and Apparatus, and Display Apparatus and Storage Medium

(71) Applicants: BEIJING BOE TECHNOLOGY DEVELOPMENT CO., LTD., Beijing (CN); BOE TECHNOLOGY GROUP CO., LTD., Chaoyang District, Beijing (CN)

(72) Inventor: Shuguo Zhang, Beijing (CN)

(21) Appl. No.: 19/487,181

(22) PCT Filed: Apr. 17, 2024
(86) PCT No.: PCT/CN2024/088386

§ 371 Date: Nov. 24, 2025

(30) Foreign Application Priority Data
May 31, 2023 (CN) 202310640025.7

(51) Int. Cl. G09G 3/34; G09G 3/20; G09G 3/36

(52) U.S. Cl. CPC G09G 3/3426; G09G 3/2007; G09G 3/36; G09G 2320/02; G09G 2320/0233; G09G 2320/066; G09G 2320/0686; G09G 2330/021; G09G 2360/16

(57) ABSTRACT

An image display apparatus includes a communication interface, a regional backlight value calculation module, a backlight diffusion simulation module. a storage module and a pixel compensation module. The communication interface is configured to receive information of a to-be-displayed image. The regional backlight value calculation module is configured to partition the to-be-displayed image based on the information of the to-be-displayed image and calculate a backlight value of each backlight block. The backlight diffusion simulation module is configured to obtain a simulated diffuse backlight value of each backlight block based on the backlight value of each backlight block. The storage module is configured to cache the information of the to-be displayed image for a preset duration. The pixel compensation module is configured to compensate pixel values of the to be displayed image based on the information of the to be-displayed image and the simulated diffuse backlight value of each backlight block.

### CROSS-REFERENCE TO RELATED APPLICATIONS

This application is the United States national phase of International Patent Application No. PCT/CN2024/088386, filed Apr. 17, 2024, and claims priority to Chinese Patent Application No. 202310640025.7, filed May 31, 2023, the disclosures of which are hereby incorporated by reference in their entireties.

### BACKGROUND OF THE INVENTION

### Field of the Invention

The present disclosure relates to the field of display technologies, and in particular, to an image display processing method and apparatus, a display apparatus, and a storage medium.

### Description of Related Art

Currently, liquid crystal display (LCD) devices have been widely used in electronic products such as mobile phones and computers. The liquid crystal display device needs to be provided with a light source by a backlight module. The traditional display manner is to provide a uniform backlight to realize the brightness control of the output image by controlling deflection of the liquid crystal.

### SUMMARY OF THE INVENTION

In an aspect, an image display processing apparatus is provided. The image display processing apparatus includes a communication interface, a regional backlight value calculation module, a backlight diffusion simulation module, a storage module, and a pixel compensation module. The communication interface is configured to receive information of a to-be-displayed image. The regional backlight value calculation module is coupled to the communication interface, and the regional backlight value calculation module is configured to: partition the to-be-displayed image based on the received information of the to-be-displayed image, and calculate a backlight value of each backlight block. The backlight diffusion simulation module is coupled to the regional backlight value calculation module, and the backlight diffusion simulation module is configured to obtain a simulated diffuse backlight value of each backlight block based on the backlight value of each backlight block. The storage module is coupled to the communication interface, and the storage module is configured to cache the information of the to-be-displayed image for a preset duration before the information of the to-be-displayed image is output. The pixel compensation module is coupled to both the storage module and the backlight diffusion simulation module; the pixel compensation module is configured to compensate pixel values of the to-be-displayed image based on the received information of the to-be-displayed image and the simulated diffuse backlight value of each backlight block to obtain compensated pixel values of the to-be-displayed image.

In some embodiments, the preset duration is substantially equal to a duration for the regional backlight value calculation module to partition the to-be-displayed image and to calculate backlight values of all backlight blocks.

In some embodiments, the image display processing apparatus further includes a backlight data processing module. The backlight data processing module is coupled to the regional backlight value calculation module. The backlight data processing module is configured to calculate a transition backlight value of each backlight block based on backlight values of each backlight block corresponding to information of each two adjacent frames of to-be-displayed images.

In some embodiments, the backlight data processing module includes a memory and an operator. The operator is coupled to the memory. The operator is configured to calculate the transition backlight value of each backlight block based on the backlight values of each backlight block corresponding to the information of each two adjacent frames of to-be-displayed images. The memory includes a plurality of memory partitions. The memory is coupled to the regional backlight value calculation module and the operator, and the memory is configured to store a backlight value of each backlight block corresponding to information of each frame of to-be-displayed image, and store the received transition backlight value of each backlight block.

In some embodiments, the image display processing apparatus further includes a synchronization signal generation module. The synchronization signal generation module is coupled to the communication interface. The synchronization signal generation module is configured to obtain a second synchronization signal based on a first synchronization signal corresponding to the information of the to-be-displayed image; a frequency of the second synchronization signal is greater than a frequency of the first synchronization signal, so that the backlight data processing module outputs the transition backlight value of each backlight block between the backlight values of each backlight block corresponding to the information of each two adjacent frames of to-be-displayed images.

In some embodiments, the frequency of the second synchronization signal is three times the frequency of the first synchronization signal.

In some embodiments, the image display processing apparatus further includes a filter processing module. The filter processing module is coupled between the backlight diffusion simulation module and the pixel compensation module. The filter processing module is configured to: select a target backlight block from all backlight blocks, the target backlight block and multiple backlight blocks around the target backlight block constituting a first matrix of n rows and n columns; and obtain an average diffuse backlight value of all backlight blocks in the first matrix based on diffuse backlight values of all the backlight blocks in the first matrix; wherein n is a positive integer.

In some embodiments, n=5.

In some embodiments, the first matrix is symmetrically arranged with the target backlight block as a center.

In some embodiments, the filter processing module is further configured to supplement, in a case where the first matrix is not symmetrically arranged with the target backlight block as a center, the first matrix in a mirror manner to from a second matrix symmetrically arranged with the target backlight block as a center.

In some embodiments, the image display processing apparatus is a driver board.

In another aspect, an image display processing apparatus is provided. The image display processing apparatus includes a communication interface, a regional backlight value calculation module, a backlight data processing module, a synchronization signal generation module, a backlight diffusion simulation module, and a pixel compensation module. The communication interface is configured to receive information of a to-be-displayed image. The regional backlight value calculation module is coupled to the communication interface, and the regional backlight value calculation module is configured to: partition the to-be-displayed image based on the received information of the to-be-displayed image, and calculate a backlight value of each backlight block. The backlight data processing module is coupled to the regional backlight value calculation module, and the backlight data processing module is configured to calculate a transition backlight value of each backlight block based on backlight values of each backlight block corresponding to information of each two adjacent frames of the to-be-displayed images. The synchronization signal generating module is coupled to the communication interface. The synchronization signal generation module is configured to obtain a second synchronization signal based on a first synchronization signal corresponding to the information of the to-be-displayed image; a frequency of the second synchronization signal is greater than a frequency of the first synchronization signal, so that the backlight data processing module outputs the transition backlight value of each backlight block between the backlight values of each backlight block corresponding to the information of each two adjacent frames of to-be-displayed images. The backlight diffusion simulation module is coupled to the regional backlight value calculation module; the backlight diffusion simulation module is configured to obtain a simulated diffuse backlight value of each backlight block based on the backlight value of each backlight block. The pixel compensation module is coupled to both the communication interface and the backlight diffusion simulation module. The pixel compensation module is configured to compensate pixel values of the to-be-displayed image based on the received information of the to-be-displayed image and the simulated diffuse backlight value of each backlight block to obtain compensated pixel values of the to-be-displayed image.

In yet another aspect, an image display processing apparatus is provided. The image display processing apparatus includes a communication interface, a regional backlight value calculation module, a backlight diffusion simulation module, a filter processing module, and a pixel compensation module. The communication interface is configured to receive information of a to-be-displayed image. The regional backlight value calculation module is coupled to the communication interface. The regional backlight value calculation module is configured to: partition the to-be-displayed image based on the received information of the to-be-displayed image, and calculate a backlight value of each backlight block. The backlight diffusion simulation module is coupled to the regional backlight value calculation module, and the backlight diffusion simulation module is configured to obtain a simulated diffuse backlight value of each backlight block based on the backlight value of each backlight block. The filter processing module is coupled between the backlight diffusion simulation module and the pixel compensation module, and the filter processing module is configured to: select a target backlight block from all backlight blocks, the target backlight block and multiple backlight block around the target backlight block constituting a first matrix of n rows and n columns, and the first matrix being symmetrically arranged with the target backlight block as a center; and obtain an average diffuse backlight value of all backlight blocks in the first matrix based on diffuse backlight values of all the backlight blocks in the first matrix, where n is a positive integer. The pixel compensation module is coupled to both the communication interface and the filter processing module; the pixel compensation module is configured to compensate pixel values of the to-be-displayed image based on the received information of the to-be-displayed image and the average diffuse backlight value of all the backlight blocks to obtain compensated pixel values of the to-be-displayed image

In yet another aspect, a display apparatus is provided. The display apparatus includes a display panel, a backlight module, and the image display processing apparatus as described in any of the above embodiments. The display panel is coupled to the image display processing apparatus, and is configured to receive the compensated pixel values of the to-be-displayed image from the image display processing apparatus, and display the to-be-displayed image. The backlight module is coupled to the image display processing apparatus and is configured to receive the backlight value of each backlight block from the image display processing apparatus to drive the backlight module to emit light.

In yet another aspect, an image display processing method is provided. The image display processing method includes: obtaining information of a to-be-displayed image; partitioning the to-be-displayed image based on the received information of the to-be-displayed image, and calculating a backlight value of each backlight block; obtaining, based on the backlight value of each backlight block, a simulated diffuse backlight value of each backlight block; caching the information of the to-be-displayed image for a preset duration; and reading the cached information of the to-be-displayed image, and compensating pixel values of the to-be-displayed image based on the received information of the to-be-displayed image and the simulated diffuse backlight value of each backlight block to obtain compensated pixel values of the to-be-displayed image.

In some embodiments, the duration that the storage module caches the information of the to-be-displayed image is substantially equal to a duration for the regional backlight value calculation module to partition the to-be-displayed image and to calculate the backlight value of each backlight block.

In some embodiments, the image display processing method further includes: calculating a transition backlight value of each backlight block based on backlight values of each backlight block corresponding to information of each two adjacent frames of to-be-displayed images.

In some embodiments, the image display processing method further includes: obtaining a second synchronization signal based on a first synchronization signal corresponding to the information of the to-be-displayed image; wherein a frequency of the second synchronization signal is greater than a frequency of the first synchronization signal, so as to output the transition backlight value of each backlight block between the backlight values of each backlight block corresponding to the information of each two adjacent frames of to-be-displayed images; and reading, under control of the second synchronization signal, the backlight value of each backlight block corresponding to the information of the former frame of to-be-displayed images in each two adjacent frames, the transition backlight value of each backlight block, and the backlight value of each backlight block corresponding to the information of the latter frame of to-be-displayed image in each two adjacent frames sequentially.

In some embodiments, the image display processing method further includes: performing filtering on the simulated diffuse backlight value of each backlight block to obtain a filtered simulated diffuse backlight value of each backlight block. Compensating the pixel values of the to-be-displayed image based on the simulated diffuse backlight value of each backlight block and the read cached information of the to-be-displayed image to obtain the compensated pixel values of the to-be-displayed image includes: compensating the pixel values of the to-be-displayed image based on the filtered simulated diffuse backlight value of each backlight block and the read cached information of the to-be-displayed image to obtain the compensated pixel values of the to-be-displayed image.

In some embodiments, performing filtering includes: selecting a target backlight area from all backlight blocks, the target backlight block and multiple backlight blocks around the target backlight block constituting a first matrix with n rows and n columns; and obtaining an average diffuse backlight value of all backlight blocks in the first matrix based on diffuse backlight values of all the backlight blocks in the first matrix; where n is a positive integer.

In yet another aspect, an image display processing method is provided. The image display processing method includes: obtaining information of a to-be-displayed image; partitioning the to-be-displayed image based on the received information of the to-be-displayed image, and calculating a backlight value of each backlight block; calculating a transition backlight value of each backlight block based on backlight values of each backlight block corresponding to information of each two adjacent frames of to-be-displayed images; obtaining a second synchronization signal based on a first synchronization signal corresponding to the information of the to-be-displayed image; wherein a frequency of the second synchronization signal is greater than a frequency of the first synchronization signal, so that the transition backlight value of each backlight block is output between the backlight values of each backlight block corresponding to the information of each two adjacent frames of to-be-displayed images; obtaining a simulated diffuse backlight value of each backlight block based on the backlight value of each backlight block; and compensating pixel values of the to-be-displayed image based on the received information of the to-be-displayed image and the simulated diffuse backlight value of each backlight block to obtain compensated pixel values of the to-be-displayed image.

In yet another aspect, an image display processing method is provided. The image display processing method includes: obtaining information of a to-be-displayed image; partitioning the to-be-displayed image based on the received information of the to-be-displayed image, and calculating a backlight value of each backlight block; obtaining a simulated diffuse backlight value of each backlight block based on the backlight value of each backlight block; selecting a target backlight block from all backlight blocks, the target backlight block and multiple backlight blocks around the target backlight block constituting a first matrix with n rows and n columns; and obtaining an average diffuse backlight value of all backlight blocks in the first matrix based on diffuse backlight values of all the backlight blocks in the first matrix; where n is a positive integer; and compensating pixel values of the to-be-displayed image based on the received information of the to-be-displayed image and the average diffuse backlight value of all the backlight blocks to obtain compensated pixel values of the to-be-displayed image.

In yet another aspect, a computer-readable storage medium is provided. The computer-readable storage medium has stored therein computer program instructions that, and the computer program instructions, when run on a computer (e.g., a display apparatus), cause the computer to perform the image display processing method as described in any one of the above embodiments.

In yet another aspect, a computer program product is provided. The computer program product includes computer program instructions, and the computer program instructions, when executed on a computer (e.g., a display apparatus), cause the computer to perform the image display processing method as described in any one of the above embodiments.

In yet another aspect, a computer program is provided. When executed by a computer (e.g., a display apparatus), the computer program causes the computer to perform the image display processing method according to any one of the above embodiments.

### BRIEF DESCRIPTION OF THE DRAWINGS

In order to describe technical solutions in the present disclosure more clearly, the accompanying drawings to be used in some embodiments of the present disclosure will be introduced briefly. Obviously, the accompanying drawings to be described below are merely drawings of some embodiments of the present disclosure, and a person of ordinary skill in the art can obtain other drawings according to those drawings. In addition, the accompanying drawings in the following description may be regarded as schematic diagrams, but are not limitations on actual sizes of products, actual processes of methods and actual timings of signals involved in the embodiments of the present disclosure.

FIG. 1 is a structural diagram of a display apparatus, in accordance with some embodiments;

FIG. 2 is a structural diagram of another display apparatus, in accordance with some embodiments;

FIG. 3 is a structural diagram of an image display processing apparatus, in accordance to some embodiments;

FIG. 4 is a structural diagram of a storage module, in accordance with some embodiments;

FIG. 5 is a diagram showing a display image of a display panel in a certain frame, in accordance with some embodiments;

FIG. 6 is a structural diagram of another image display processing apparatus, in accordance with some other embodiments;

FIG. 7 is a structural diagram of a backlight data processing module, in accordance with some embodiments;

FIG. 8 is a structural diagram of yet another image display processing apparatus, in accordance with some embodiments;

FIG. 9 is a waveform diagram of a first synchronization signal and a second synchronization signal, in accordance with some embodiments;

FIG. 10 is a diagram showing a display image of a display panel in a certain frame, in accordance with some embodiments;

FIG. 11 is a structural diagram of yet another image display processing apparatus, in accordance with yet some other embodiments;

FIG. 12 is a structural diagram of a first matrix, in accordance with some embodiments;

FIG. 13 is a structural diagram of a second matrix, in accordance with some embodiments;

FIG. 14 is a flow diagram of an image display processing method, in accordance with some embodiments;

FIG. 15 is a flow diagram of another image display processing method, in accordance with some embodiments;

FIG. 16 is a flow diagram of yet another image display processing method, in accordance with some embodiments;

FIG. 17 is a structural diagram of yet another image display processing apparatus, in accordance with some embodiments;

FIG. 18 is a structural diagram of yet another image display processing apparatus, in accordance with some embodiments;

FIG. 19 is a flow diagram of yet another image display processing method, in accordance with some embodiments;

FIG. 20 is a flow diagram of yet another image display processing method, in accordance with some embodiments;

FIG. 21 is a structural diagram of yet another image display processing apparatus, in accordance with some embodiments; and

FIG. 22 is a flow diagram of yet another image display processing method, in accordance with some embodiments.

### DESCRIPTION OF THE INVENTION

The technical solutions in some embodiments of the present disclosure will be described clearly and completely below with reference to the accompanying drawings, and obviously, the described embodiments are merely some but not all embodiments of the present disclosure. All other embodiments obtained by a person of ordinary skill in the art based on embodiments provided in the present disclosure shall be included in the protection scope of the present disclosure.

Unless the context requires otherwise, throughout the specification and the claims, the term “comprise” and other forms thereof such as the third-person singular form “comprises” and the present participle form “comprising” are construed as an open and inclusive meaning, i.e., “including, but not limited to”. In the description of the specification, the terms such as “one embodiment”, “some embodiments”, “exemplary embodiments”, “example”, “specific example”, or “some examples” are intended to indicate that specific features, structures, materials, or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics described may be included in any one or more embodiments or examples in any suitable manner.

Hereinafter, terms such as “first” and “second” are used for descriptive purposes only, and are not to be construed as indicating or implying the relative importance or implicitly indicating the number of indicated technical features. Thus, a feature defined with “first” or “second” may explicitly or implicitly include one or more of the features. In the description of the embodiments of the present disclosure, the terms “a plurality of”, “the plurality of” and “multiple” each mean two or more unless otherwise specified.

Some embodiments may be described using the terms “coupled”, “connected” and their derivatives. The term “connected” should be understood in a broad sense, for example, the term “connected” may represent a fixed connection, or a detachable connection, or a one-piece connection; alternatively, the term “connected” may represent a direct connection, or an indirect connection through an intermediate medium. The term “coupled”, for example, indicates that two or more components are in direct physical or electrical contact. The term “coupled” or “communicatively coupled” may also indicate that two or more components are not in direct contact with each other, but still cooperate or interact with each other. The embodiments disclosed herein are not necessarily limited to the context herein.

The phrase “at least one of A, B and C” has the same meaning as the phrase “at least one of A, B or C”, both including following combinations of A, B and C: only A, only B, only C, a combination of A and B, a combination of A and C, a combination of B and C, and a combination of A, B and C.

The phrase “A and/or B” includes following three combinations: only A, only B, and a combination of A and B.

As used herein, the term “if” is, optionally, construed as “when” or “in a case where” or “in response to determining that” or “in response to detecting”, depending on the context. Similarly, depending on the context, the phrase “if it is determined that” or “if [a stated condition or event] is detected” is optionally construed as “in a case where it is determined that” or “in response to determining that” or “in a case where [the stated condition or event] is detected” or “in response to detecting [the stated condition or event].

The use of the phrase “applicable to” or “configured to” herein means an open and inclusive expression, which does not exclude devices that are applicable to or configured to perform additional tasks or steps.

In addition, the use of the phrase “based on” is meant to be open and inclusive, since a process, step, calculation or other action that is “based on” one or more of the stated conditions or values may, in practice, be based on or according to additional conditions or values exceeding those stated.

The term such as “about”, “substantially” or “approximately” as used herein includes a stated value and an average value within an acceptable range of deviation of a particular value, and the acceptable range of deviation is determined, for example, by a person of ordinary skill in the art, considering measurement in question and errors (i.e., limitations of a measurement system) associated with measurement of a particular quantity.

The term such as “parallel”, “perpendicular” or “equal” as used herein includes a stated condition and a condition similar to the stated condition within an acceptable range of deviation, and the acceptable range of deviation is determined, for example, by a person of ordinary skill in the art, considering measurement in question and errors (i.e., limitations of a measurement system) associated with measurement of a particular quantity. For example, the term “parallel” includes absolute parallelism and approximate parallelism, and an acceptable range of deviation of the approximate parallelism may be, for example, a deviation within 5°; the term “perpendicular” includes absolute perpendicularity and approximate perpendicularity, and an acceptable range of deviation of the approximate perpendicularity may also be, for example, a deviation within 5°; and the term “equal” includes absolute equality and approximate equality, and an acceptable range of deviation of the approximate equality may be, for example, a difference between two equals being less than or equal to 5% of either of the two equals.

Exemplary embodiments are described herein with reference to sectional views and/or plan views as idealized exemplary drawings. In the drawings, thicknesses of layers and sizes of regions are enlarged for clarity. Variations in shapes relative to the accompanying drawings due to, for example, manufacturing technologies and/or tolerances may be envisaged. Therefore, the exemplary embodiments should not be construed to be limited to the shapes of regions shown herein, but to include deviations in the shapes due to, for example, manufacturing. For example, an etched region shown as a rectangle generally has a feature of being curved. Therefore, the regions shown in the accompanying drawings are schematic in nature, and their shapes are not intended to show actual shapes of the regions in a device, and are not intended to limit the scope of the exemplary embodiments.

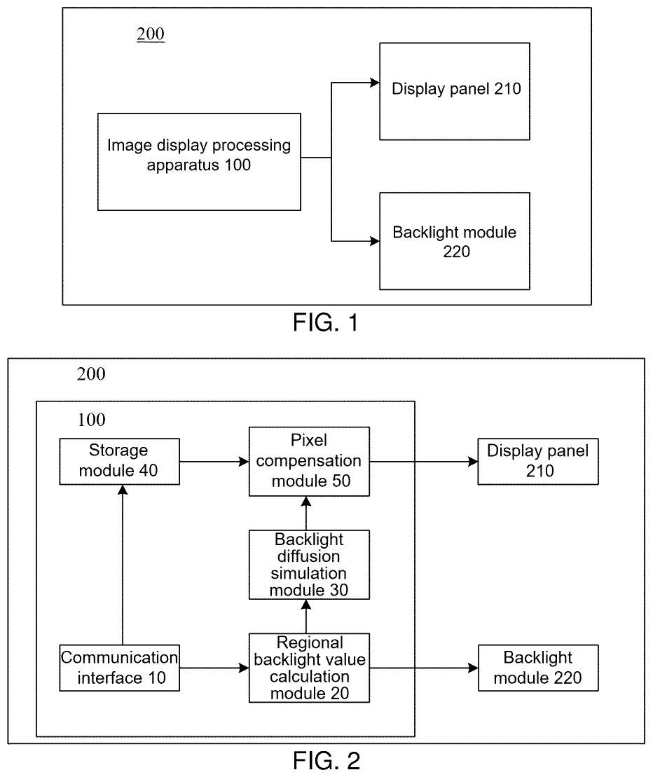

FIG. 1 is a structural diagram of a display apparatus, in accordance with some embodiments.

Some embodiments of the present disclosure provide a display apparatus. Referring to FIG. 1, a display apparatus 200 includes a display panel 210, a backlight module 220 and an image display processing apparatus 100.

In some examples, the display apparatus 200 may be any apparatus that displays an image whether in motion (e.g., a video) or stationary (e.g., a still image), and whether textual or graphical. More specifically, it is expected that the embodiments may be implemented in or associated with various electronic apparatuses, which include (but is not limit to), for example, a mobile phone, a wireless device, a personal digital assistant (PDA), a hand-held or portable computer, a GPS receiver/navigator, a camera, an MP4 video player, a video camera, a game console, a watch, a clock, a calculator, a TV monitor, a flat panel display, a computer monitor, a car display (e.g., an odometer display), a navigator, a cockpit controller and/or display, a display in camera view (e.g., a display for a rear camera in a vehicle), an electronic photo, an electronic billboard or indicator, a projector, a building structure, a packaging and an aesthetic structure (e.g., a display for an image of a piece of jewelry).

In addition, the display apparatus 200 may be an independent head-mounted display apparatus, or an integrated head-mounted display apparatus. The independent head-mounted display apparatus needs to be combined with other processing devices to achieve the display of information. The integrated head-mounted display apparatus may achieve the display of information through the processing device contained in itself. The display apparatus may be used to realize virtual reality (VR) or augmented reality (AR).

In some examples, the display panel 210 may be a liquid crystal display (LCD) panel. In the case where the display panel 210 is the liquid crystal display panel, the display panel 210 includes an array substrate, an opposite substrate (which may be a color filter substrate) and a liquid crystal layer. The array substrate and the opposite substrate are oppositely arranged, and the liquid crystal layer is located between the opposite substrate and the array substrate.

A first polarizer is provided on the array substrate, and a second polarizer is provided on the opposite substrate, and polarization directions of the first polarizer and the second polarizer are perpendicular to each other. The liquid crystal molecules of the liquid crystal layer deflect due to the action of the driving electric field formed between the pixel electrode arranged in the array substrate and the common electrode arranged in the array substrate or common electrode arranged in the opposite substrate to control the polarization direction of light and control the transmittance of light with the cooperation of the first polarizer and the second polarizer, thereby realizing grayscale display.

In some examples, the backlight module 220 is disposed on the backlight side of the display panel 210, that is, the backlight module 220 is disposed on a side away from the light-exit side of the display panel 210; the backlight module 220 provides a planar light source for the display panel 210. The backlight module 220 may include a backlight driver chip, a backlight source, a light guide plate, and an optical film disposed on a light-exit side of the light guide plate.

For example, the driver chip may be MZ315HEP-A44, and the present disclosure is not limited thereto.

For example, the optical film may include a diffuser sheet and/or a brightness enhancement film.

For example, the light guide plate is wedge-shaped or flat-plate-shaped.

For example, the brightness enhancement film may include at least one of a prismatic film (brightness enhancement film, abbreviated as BEF) and a dual brightness enhancement film (abbreviated as DBEF).

For example, the backlight module 220 may be a direct-type backlight module. The backlight source includes a plurality of light-emitting devices. The light-emitting device may be any of a light-emitting diode (LED), a mini light-emitting diode (abbreviated as mini LED) or a micro light-emitting diode (abbreviated as micro LED).

After research, it was found that the backlight source used for the traditional display apparatus 200 is a whole surface light source. When the brightness is adjusted, the entire image will become bright or dark at the same time, which will cause the display apparatus 200 to have a low contrast problem of the display image, affecting the user's viewing experience.

The display apparatus 200 provided in the embodiments of the present disclosure is designed to achieve a high contrast to improve the user's viewing experience. An image display processing apparatus 100 coupled to both the display panel 210 and the backlight module 220 is additionally provided in the display apparatus 200. Furthermore, the display apparatus 200 may utilize the image display processing apparatus 100 to implement backlight control of the backlight module 220 and pixel compensation of the display panel 210, so as to improve the display effect of the display apparatus 200 and improve the user's viewing experience.

In some examples, the display apparatus 200 may use local dimming technology (LD) to control the display panel 210 through the image display processing apparatus 100 to perform pixel compensation and control the backlight module 220 to perform backlight control, thereby improving the display quality of the display panel 210. The local dimming technology may not only reduce the power consumption of the display panel 210, but also realize dynamic dimming of each backlight block of the backlight module 220, greatly improving the contrast of the display image and improving the display quality of the display apparatus 200, so as to provide users with a good visual experience.

For example, the local dimming technology may partition the entire backlight module 220 into a plurality of independently drivable backlight blocks, each backlight block includes one or more light-emitting devices. The driving current of the light-emitting devices of the backlight blocks corresponding to different parts of the display image is automatically adjusted according to the grayscales that need to be displayed in these parts, so as to achieve independent adjustment of the brightness of each backlight block in the backlight module 220, thereby improving the contrast of the display panel 210. The local dimming technology is usually only applicable to direct-type backlight units, and a plurality of light-emitting devices serving as light sources are, for example, evenly distributed across the entire backplate.

It will be noted that the backlight block is a virtual boundary and does not exist in actual production.

Specifically, the description will be made by taking a 4K resolution e-sports display device as an example.

The backlight module 220 may be partitioned into 48 blocks in a row direction and 24 blocks in a column direction. Based on this, the backlight module 220 may be partitioned into 1152 backlight blocks.

Correspondingly, the display panel 210 may also be divided into 48 blocks in the row direction and 24 blocks in the column direction. Based on this, the display panel 210 may have display blocks that correspond one-to-one to the multiple backlight blocks in the backlight module 220.

Information of each frame of to-be-displayed image is segmented according to the multiple display blocks of the display panel 210, and a part of the information of each frame of to-be-displayed image corresponding to each display block is used as an image block information.

Based on this, the display apparatus 200 may use the image display processing apparatus 100 to obtain the backlight value of each corresponding backlight block based on the information of to-be-displayed image of the display panel 210, and to transmit the backlight value to the driver chip of the backlight module 220 to drive, by using the driver chip, the backlight source to emit light. That is, the brightness of the corresponding backlight block in the backlight module 220 may be adjusted according to the image to be displayed on the display panel 210. For the part with high brightness (grayscale) of the image, the brightness of the corresponding backlight block is also high, and for the part with low brightness of the image, the brightness of the corresponding backlight block is also low, thereby achieving the purpose of reducing backlight power, improving the contrast of the display panel 210, and improving the display quality.

Furthermore, the display apparatus 200 may also utilize the image display processing apparatus 100 to obtain compensated pixel values of the to-be-displayed image based on the to-be-displayed image on the display panel 210, and to send the compensated pixel values to the display panel 210, so that the display panel 210 displays the to-be-displayed image.

In some examples, the display apparatus 200 may further include a system on chip (abbreviated as SOC). The image display processing apparatus 100 is coupled between the system-on-chip and the display panel 210, and the image display processing apparatus 100 is coupled between the system-on-chip and the backlight module 220. Furthermore, before the display apparatus 200 transmits the information of the to-be-displayed image to the display processing apparatus 100, the system-on-chip may be used to process the information of the to-be-displayed image. For example, image correction processing is performed to improve the accuracy of the information of the to-be-displayed image.

In some examples, the display panel 210 may further include a driver control circuit coupled to the image display processing apparatus 100. The display panel 210 further includes a data driving circuit (also referred to as a source driver IC) and a scanning driving circuit (gate driver on array) that are coupled to the driver control circuit. The driver control circuit is configured to provide electrical signals to the data driving circuit and the scanning driving circuit, so that the display panel 210 displays images.

For example, the driver control circuit is configured to output a first control signal and image data to the data driving circuit 330 and output a second control signal to the scanning driving circuit 320 based on compensated pixel values of the to-be-displayed image. The first control signal is configured to control the operation timing of the data driving circuit, and the second control signal is configured to control the operation timing of the scanning driving circuit. Based on this, the data driving circuit and the scanning driving circuit may be used to form a driving electric field between the pixel electrode arranged in the array substrate and the common electrode arranged in the array substrate or common electrode arranged in the opposite substrate, so that the liquid crystal molecules deflect utilized to the electric field. Thus, the polarization direction of the light is controlled, and the transmittance of the light is controlled with the cooperation of the first polarizer and the second polarizer, thereby realizing grayscale display.

Specifically, the driver control circuit may be a timing control circuit (also referred to as a timer control register (TCON for short)).

In summary, the display apparatus 200 provided in the embodiments of the present disclosure includes a display panel 210, a backlight module 220 and an image display processing apparatus 100. The image display processing apparatus 100, in conjunction with the display panel 210 and the backlight module 220, may be used to implement local dimming of the display apparatus 200. Furthermore, it may be beneficial to reduce backlight power, improve the contrast of the display image, and improve the display quality.

However, based on the implementation of the above-mentioned local dimming, it has been found through researches that the display effect of the display apparatus 200 is not ideal. The reasons that lead to unsatisfactory display effect of the display apparatus 200 are as follows.

The image display processing apparatus 100 needs to store a frame of image during the process of backlight control and pixel compensation to complete the backlight statistics and pixel compensation, which will cause the display apparatus 200 to delay the output of the image by at least one frame in a case where the image display processing device 100 is provided to adjust. That is, the backlight module 220 obtaining data will be delayed by at least one frame relative to the display panel 210 obtaining data, which will cause the display panel 210 and the backlight module 220 to be mismatched, affecting the display effect of the display apparatus 200.

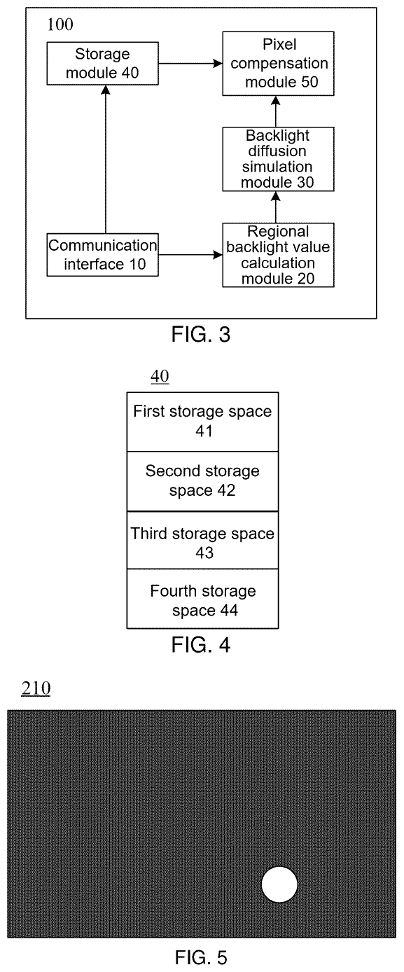

FIG. 2 is a structural diagram of a display apparatus, in accordance with some other embodiments; FIG. 3 is a structural diagram of an image display processing apparatus, in accordance with some other embodiments.

Embodiments of the present disclosure provide an image display processing apparatus 100. Referring to FIGS. 2 and 3, the image display processing apparatus 100 includes a communication interface 10, a regional backlight value calculation module 20, a backlight diffusion simulation module 30, a storage module 40, and a pixel compensation module 50.

The communication interface 10 is configured to receive information of a to-be-displayed image; the communication interface 10 is coupled to both the storage module 40 and the regional backlight value calculation module 20. The communication interface 10 is further configured to transmit the received information of the to-be-displayed image to the storage module 40 and the regional backlight value calculation module 20.

In some examples, the to-be-displayed image is an image that the display panel 210 currently needs to display, and the information of the to-be-displayed image may include a resolution of the to-be-displayed image, and the image three-channel values of each pixel.

For example, image channels refer to separate red, green, and blue parts in the RGB color mode. In other words, a complete image is composed of three channels of red, green and blue, which work together to produce a complete image. For a complete image, the three channels of red, green and blue are indispensable. Even if there seems to be no blue in the image, it may only be considered that the luminance of the blue light is 0 or the red and green channels of each pixel value are not all 0, but it cannot be considered that there is no blue channel.

The regional backlight value calculation module 20 is coupled between the communication interface 10 and the backlight diffusion simulation module 30. The regional backlight value calculation module 20 is configured to: partition the to-be-displayed image based on the received information of the to-be-displayed image, calculate the backlight value of each backlight block, and transmit the backlight value of each backlight block to the backlight diffusion simulation module 30.

In some examples, the regional backlight value calculation module 20 may partition the to-be-displayed image based on the received information of the to-be-displayed image to obtain information of multiple image blocks. Furthermore, the regional backlight value calculation module 20 may further calculate, based on information of an image block of the to-be-displayed image, a backlight value of a corresponding backlight block, so as to obtain the backlight value of each backlight block. The number of pieces of information of the image blocks corresponds to the number of backlight blocks in a one-to-one manner, that is, information of one image block corresponds to the backlight value of one backlight block.

Based on this, the regional backlight value calculation module 20 may obtain the backlight value of the corresponding backlight block based on the information of different blocks of the to-be-displayed image, so that the backlight value of each backlight block may be used for driving separately.

For example, the regional backlight value calculation module 20 may partition the to-be-displayed image based on the received information of the to-be-displayed image to obtain the information of multiple image blocks. After obtaining the information of multiple image blocks, the regional backlight value calculation module 20 calculates the maximum value of regional pixels in a backlight block corresponding to information of an image block, and uses the maximum value of regional pixels as the backlight value of the corresponding backlight block.

The calculation method of the backlight value of the backlight block adopts the maximum value method, i.e., the maximum value of the regional pixels is used as the backlight value, so as to meet the display requirements of the pixel with the greatest pixel value, but the embodiments of the present disclosure are not limited thereto. For example, the backlight value may also refer to the luminance value required when the backlight block is lit or the driving voltage/current value of the regional backlight source that corresponds to the brightness value. Depending on the specific implementation method, the numerical properties referred to by the backlight value may be different, but the embodiments of the present disclosure are not limited to the above.

In addition, the regional backlight value calculation module 20 may further be coupled to the backlight driver chip in the backlight module 220. The regional backlight value calculation module 20 is further configured to transmit the obtained backlight value of each backlight block to the backlight driver chip of the backlight module 220, so that the backlight driver chip drives the backlight source of the backlight module 220 based on the backlight values of all the backlight blocks, enabling the backlight module 220 to emit light. Furthermore, the backlight module 220 emits light based on the backlight value of each backlight block, i.e., the backlight value of each backlight block may be used to individually drive the backlight source in the respective backlight block of the backlight module 220 to achieve local dimming of the backlight module 220.

The backlight diffusion simulation module 30 is coupled to the regional backlight value calculation module 20. The backlight diffusion simulation module 30 is configured to obtain a simulated diffuse backlight value of each backlight block based on the backlight value of each backlight block.

The light emitted from any backlight block will illuminate an adjacent backlight block, and various positions in the same backlight block are affected differently by the light diffusion of the adjacent backlight block. Based on this, there is a certain difference between the backlight values irradiated from the backlight block and the corresponding display block of the display panel 210.

Furthermore, the backlight diffusion simulation module 30 may be used to simulate the actual backlight conditions after obtaining the backlight value of each backlight block and before performing pixel compensation, so as to ameliorate the influence of light diffusion on the light emitted by multiple backlight blocks of the backlight module 220 to ameliorate the blocking phenomenon.

In some examples, the backlight diffusion simulation module 30 may perform backlight simulation processing based on the backlight value of each backlight block by convolving a light diffusion function obtained by experimental measurement with the backlight value of each backlight block. That is, by performing convolution processing on the light diffusion function and the backlight value, the backlight value of the boundary region of the backlight blocks may present a certain degree of smooth transition, thereby achieving the effect of simulating actual backlight.

For example, the light diffusion function obtained by experimental measurement may be a light diffusion function that is measured during a regional backlight adjustment experiment/test and can simulate the actual backlight effect well. The actual value may be adjusted as needed, and the specific value is not given here.

For example, the light diffusion function may be a point spread function (PSF for short). It should be noted that, in addition to the point spread function, other fitting function relationships may also be used, and the embodiments of the present disclosure are not limited thereto.

The storage module 40 is coupled between the communication interface 10 and the pixel compensation module 50. The storage module 40 is configured to cache the information of the to-be-displayed image for a preset period of time and then transmit the information of the to-be-displayed image to the pixel compensation module 50.

In some examples, the preset duration for the storage module 40 to cache the information of the to-be-displayed image is substantially equal to a sum of durations for the regional backlight value calculation module 20 to partition the to-be-displayed image and to calculate the backlight values of all the backlight blocks.

In some examples, the storage module 40 includes multiple storage spaces. When the storage module 40 receives information of an n-th frame of to-be-displayed image transmitted from the communication interface 10, the information of the n-th frame of to-be-displayed image is stored in a first storage space of the multiple storage spaces; when the storage module 40 receives information of an (n+m)-th frame of to-be-displayed image transmitted from the communication interface 10, the information of the (n+m)-th frame of to-be-displayed image is stored in another storage space of the multiple storage spaces, and at the same time, the information of the n-th frame of to-be-displayed image stored in the first storage space is read to enable the information of the n-th frame of to-be-displayed image to be output.

Based on this, the storage module 40 may be used to cache the information of the n-th frame of to-be-displayed image, and the storage module 40 may be used to delay the transmitting of the information of the n-th frame of to-be-displayed image by m frames.

The pixel compensation module 50 is coupled to both the storage module 40 and the backlight diffusion simulation module 30. The pixel compensation module 50 is configured to compensate pixel values of the to-be-displayed image based on the received cached information of the to-be-displayed image and the simulated diffuse backlight values of all the backlight blocks to obtain compensated pixel values of the to-be-displayed image.

Since the storage module 40 may be used to delay the time when the pixel compensation module 50 receives the information of the n-th frame of to-be-displayed image, the pixel compensation module 50 may receive the simulated diffuse backlight values of all the backlight blocks obtained by the backlight diffusion simulation module 30 based on the information of the n-th frame of to-be-displayed image and receive the information of the n-th frame of to-be-displayed image transmitted by the storage module 40 that has cached for m frames substantially at the same time. That is, the pixel compensation module 50 may compensate the pixel values of the n-th frame of to-be-displayed image based on the information of the n-th frame of to-be-displayed image and the simulated diffuse backlight values of all the backlight blocks corresponding to the information of the n-th frame of to-be-displayed image, so as to obtain the compensated pixel values of the n-th frame of to-be-displayed image, thereby improving the accuracy of the compensated pixel value of the to-be-displayed image.

In addition, since the preset duration for the storage module 40 to cache the information of the to-be-displayed image is substantially equal to the duration for the regional backlight value calculation module 20 to partition the to-be-displayed image and to calculate the backlight values of all the backlight blocks, the image display processing apparatus 100 may output the compensated pixel values of the n-th frame of to-be-displayed image and the backlight values of all the backlight blocks corresponding to the n-th frame of to-be-displayed image approximately at the same time.

As described above, in a case where the image display processing apparatus 100 is applied to the display apparatus 200, the time when the backlight module 220 obtains the backlight values of all the backlight blocks corresponding to the n-th frame of to-be-displayed image is substantially same as the time when the display panel 210 obtains the compensated pixel values of the n-th frame of to-be-displayed image. Based on this, the contrast of the display panel 210 may be improved, which is beneficial to improving the display effect of the display panel 210.

In some examples, the description will be made by taking an example in which the duration for the regional backlight value calculation module 20 to partition the to-be-displayed image and to calculate the backlight values of all the backlight blocks is approximately one frame.

In this case, the preset duration for the storage module 40 to cache the information of each to-be-displayed image may be 1 frame.

For example, the storage module 40 includes multiple storage spaces. When the storage module 40 receives the information of the n-th frame of to-be-displayed image transmitted from the communication interface 10, the information of the n-th frame of to-be-displayed image is stored in a first storage space of the multiple storage spaces; when the storage module 40 receives the information of an (n+1)-th frame of to-be-displayed image transmitted from the communication interface 10, the information of the (n+1)-th frame of to-be-displayed image is stored in a second storage space of the multiple storage spaces, and at the same time, the information of the n-th frame of to-be-displayed image stored in the first storage space is read to enable the information of the n-th frame of to-be-displayed image to be output.

Based on this, the storage module 40 may be used to cache the information of the n-th frame of to-be-displayed image, so as to enable the information of the n-th frame of to-be-displayed image to be output with a delay of 1 frame. That is, the storage module 40 is used to cache the information of the to-be-displayed image for the preset duration to compensate for the calculation duration required by the regional backlight value calculation module 20. Thus, it is possible to delay the time for the pixel compensation module 50 to receive the information of the to-be-displayed image, so that the time when the pixel compensation module 50 receives the information of the to-be-displayed image is substantially same as the time when the pixel compensation module 50 receives the compensated pixel values of the to-be-displayed image. As a result, the image display processing apparatus 100 may output the compensated pixel values of the n-th frame of to-be-displayed image and the backlight values of all the backlight blocks corresponding to the n-th frame of to-be-displayed image substantially at the same time, so that the time when the backlight module 220 obtains the backlight values of all the backlight blocks corresponding to the n-th frame of to-be-displayed image is substantially same as the time when the display panel 210 obtains the compensated pixel values of the n-th frame of to-be-displayed image. Therefore, it is beneficial to improving the uniformity of the display substrate 210, and improving the display quality of the display substrate 210.

In some other examples, the description will be made by taking an example in which the duration for the regional backlight value calculation module 20 to partition the to-be-displayed image and to calculate the backlight values of all the backlight blocks is approximately 2 frames.

In this case, the preset duration for the storage module 40 to cache information of each to-be-displayed image may be 2 frames.

For example, the storage module 40 includes multiple storage spaces. When the storage module 40 receives the information of the n-th frame of to-be-displayed image transmitted from the communication interface 10, the information of the n-th frame of to-be-displayed image is stored in a first storage space of the multiple storage spaces; when the storage module 40 receives the information of an (n+1)-th frame of to-be-displayed image transmitted from the communication interface 10, the information of the (n+1)-th frame of to-be-displayed image is stored in a second storage space of the multiple storage spaces; when the storage module 40 receives the information of an (n+2)-th frame of to-be-displayed image transmitted from the communication interface 10, the information of the (n+2)-th frame of to-be-displayed image is stored in a third storage space of the multiple storage spaces, and at the same time, the information of the n-th frame of to-be-displayed image stored in the first storage space is read to enable the information of the n-th frame of to-be-displayed image to be output.

Based on this, the storage module 40 may be used to cache the information of the n-th frame of to-be-displayed image, so as to enable the information of the n-th frame of to-be-displayed image to be output with a delay of 2 frame. That is, the storage module 40 is used to cache the information of the to-be-displayed image for the preset duration to compensate for the calculation duration required by the regional backlight value calculation module 20. Thus, it is possible to delay the time for the pixel compensation module 50 to receive the information of the to-be-displayed image, so that the time when the pixel compensation module 50 receives the information of the to-be-displayed image is substantially same as the time when the pixel compensation module 50 receives the compensated pixel values of the to-be-displayed image. As a result, the image display processing apparatus 100 may output the compensated pixel values of the n-th frame of to-be-displayed image and the backlight values of all the backlight blocks corresponding to the n-th frame of to-be-displayed image substantially at the same time, so that the time when the backlight module 220 obtains the backlight values of all the backlight blocks corresponding to the n-th frame of to-be-displayed image is substantially same as the time when the display panel 210 obtains the compensated pixel values of the n-th frame of to-be-displayed image. Therefore, it is beneficial to improving the uniformity of the display substrate 210, and improving the display quality of the display substrate 210.

In addition, in a case where other modules also require a duration to calculate before the pixel compensation module 50 receives the simulated diffuse backlight values of all the backlight blocks, the storage module 40 may also be used to cache the information of the to-be-displayed image for a preset duration, so that the pixel compensation module 50 receives the information of the n-th frame of to-be-displayed image and the simulated diffuse backlight values of all the backlight blocks corresponding to the information of the n-th frame of to-be-displayed image substantially at the same time. The embodiments of the present disclosure do not limit the above.

FIG. 4 is a structural diagram of a storage module, in accordance with some embodiments.

In some other examples, the description will be made by taking an example in which the storage module 40 includes four storage partitions, and the duration for the regional backlight value calculation module 20 to partition the to-be-displayed image and to calculate the backlight values of all the backlight blocks is approximately one frame.

The four storage partitions in the storage module 40 are a first storage space 41, a second storage space 42, a third storage space 43 and a fourth storage space 44.

When the storage module 40 receives the information of the n-th frame of to-be-displayed image from the communication interface 10, the information of the n-th frame of to-be-displayed image is stored in the first storage space 41; when the storage module 40 receives the information of the (n+1)-th frame of to-be-displayed image from the communication interface 10, the information of the (n+1)-th frame of to-be-displayed image is stored in the second storage space 42, and at the same time, the information of the n-th frame of to-be-displayed image stored in the first storage space 41 is read to enable the information of the n-th frame of to-be-displayed image to be output; when the storage module 40 receives the information of the (n+2)-th frame of to-be-displayed image from the communication interface 10, the information of the (n+2)-th frame of to-be-displayed image is stored in the third storage space 43, and at the same time, the (n+1)-th frame of to-be-displayed image stored in the second storage space 42 is read to enable the information of the (n+1)-th frame of to-be-displayed image to be output; moreover, when the storage module 40 receives information of an (n+3)-th frame of to-be-displayed image from the communication interface 10, the information of an (n+3)-th frame of to-be-displayed image is stored in the fourth storage space 44, and at the same time, the information of the (n+2)-th frame of to-be-displayed image stored in the third storage space 43 is read to enable the information of the (n+2)-th frame of to-be-displayed image to be output. In addition, when the storage module 40 receives information of an (n+4)-th frame of to-be-displayed image from the communication interface 10, the information of the (n+4)-th frame of to-be-displayed image is stored in the first storage space 41, and at the same time, the information of the (n+3)-th frame of to-be-displayed image stored in the fourth storage space 44 is read to enable the information of the (n+3)-th frame of to-be-displayed image to be output; and the storage is performed in cyclic order to achieve that the storage module 40 is used to delay the transmitting of the information of the n-th frame of to-be-displayed image by 1 frame. As a result, the duration for the storage module 40 to cache the information of the to-be-displayed image may be substantially equal to the duration for the regional backlight value calculation module 20 to partition the to-be-displayed image and to calculate the backlight values of all the backlight blocks.

It will be noted that, due to certain uncontrollable errors, the difference between the duration for the storage module 40 to cache the information of the to-be-displayed image and the duration for the regional backlight value calculation module 20 to partition the to-be-displayed image and to calculate the backlight values of all the backlight blocks is less than 30% of 1 frame, which may be considered that the duration for the storage module 40 to cache the information of the to-be-displayed image and the duration for the regional backlight value calculation module 20 to partition the to-be-displayed image and to calculate the backlight values of all the backlight blocks are substantially equal.

In summary, in the image display processing apparatus 100 provided by the embodiments of the present disclosure, the storage module 40 may be used to cache the information of the to-be-displayed image, and transmit the information of the to-be-displayed image to the pixel compensation module 50 with a delay. The duration for the storage module 40 to cache the information of the to-be-displayed image is set to be substantially equal to the duration for the regional backlight value calculation module 20 to partition the to-be-displayed image and to calculate the backlight values of all the backlight blocks. Based on this, the time when the backlight module 220 obtains the backlight values of all the backlight blocks corresponding to the information of the n-th frame of to-be-displayed image is substantially the same as the time when the display panel 210 obtains the compensated pixel values of the n-th frame of to-be-displayed image. Thus, the contrast of the display panel 210 may be improved, which is beneficial to improving the display effect of the display panel 210.

In some embodiments, as shown in FIG. 4, the storage module 40 may be a double data rate synchronous dynamic random access memory (abbreviated as DDR).

In some embodiments, as shown in FIG. 2, the image display processing apparatus 100 is a driver board.

In some examples, the image display processing apparatus 100 may be a field programmable gate array (abbreviated as FPGA).

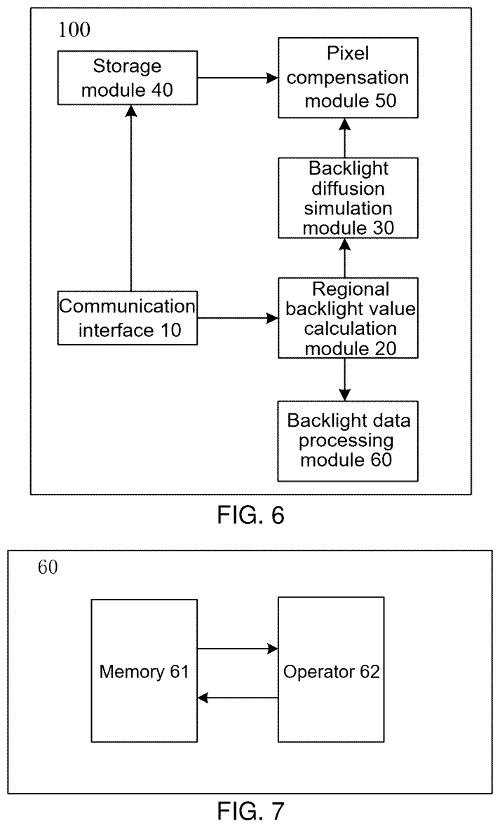

FIG. 5 is a diagram showing a display image of a display panel in a certain frame, in accordance with some embodiments, and FIG. 6 is a structural diagram of an image display processing apparatus, in accordance with some embodiments.

Based on this, referring to FIGS. 2 and 6, in some embodiments, the image display processing apparatus 100 may further include a backlight data processing module 60. The backlight data processing module 60 is coupled between the regional backlight value calculation module 20 and the backlight module 220 (referring to FIG. 1 or 2). The backlight data processing module 60 is configured to store a backlight value of each backlight block corresponding to information of each frame of to-be-displayed image, and calculate a transition backlight value of each backlight block based on backlight values of the backlight block corresponding to the information of each two adjacent frames of to-be-displayed images.

Based on this, the backlight data processing module 60 may store the backlight value of each backlight block corresponding to the information of each frame of to-be-displayed image and the transition backlight value of each backlight block obtained based on the backlight values of each backlight block corresponding to the information of each two adjacent frames of to-be-displayed images. Furthermore, the backlight data processing module 60 may output the obtained transition backlight value of each backlight block by inserting the transition backlight value of each backlight block between the backlight values of the backlight block corresponding to the information of each two adjacent frames of to-be-displayed images. By utilizing the transition backlight value of each backlight block, it is possible to reduce the difference between the backlight values of each backlight block corresponding to the information of two adjacent frames of to-be-displayed images.

Furthermore, in the case where the backlight data processing module 60 is used to output the obtained transition backlight value of each backlight block to the backlight module 220 between the backlight values of the backlight block corresponding to the information of each two adjacent frames of to-be-displayed images, and the display panel 210 performs dynamic display, the backlight module 220 may sequentially read the backlight value of each backlight block corresponding to information of a former frame of to-be-displayed image, the transition backlight value of each backlight block, and the backlight value of each backlight block corresponding to the information of a later frame of to-be-displayed image to emit light, which may help reduce the problem of backlight flickering caused by the great brightness difference between two adjacent frames when the display panel 210 performs dynamic display, thereby improving the display effect of the display panel 210.

In some examples, the backlight data processing module 60 may obtain an average backlight value of each backlight block corresponding to the information of each two adjacent frames of to-be-displayed images based on the backlight values of the backlight block corresponding to the information of the two adjacent frames of to-be-displayed images. That is, an average value of the backlight values of each backlight block corresponding to the information of two adjacent frames of to-be-displayed images is calculated to obtain the backlight average value of the corresponding backlight block.

Based on this, the difference between the backlight average value of each backlight block and each of the backlight values of the backlight block corresponding to the information of two adjacent frames of to-be-displayed image may be made small, which may help reduce the problem of backlight flickering caused by the great brightness difference between two adjacent frames when the display panel 210 performs dynamic display, thereby improving the display effect of the display panel 210.

FIG. 7 is a structural diagram of a backlight data processing module, in accordance with some embodiments.

In some embodiments, the backlight data processing module 60 includes a memory 61 and an operator 62.

The memory 61 is coupled to both the regional backlight value calculation module 20 and the operator 62. The memory 61 is configured to receive the backlight value of each backlight block corresponding to information of each frame of to-be-displayed image from the regional backlight value calculation module 20 and send the backlight value to the operator 62. The memory 61 includes multiple memory partitions. The memory 61 may store the backlight value of each backlight block corresponding to the information of each frame of to-be-displayed image from the regional backlight value calculation module 20 in a part of the plurality of memory partitions.

The operator 62 is coupled to the memory 61, and the operator 62 is configured to calculate the transition backlight value of each backlight block based on the backlight values of the backlight block corresponding to information of each two adjacent frames of to-be-displayed images, and transmit the calculated transition backlight value of each backlight block to another part of the multiple memory partitions of the memory 61.

Based on this, the multiple memory partitions of the memory 61 are respectively used to store the backlight value of each backlight block corresponding to information of each frame of to-be-displayed image, and to store the received transition backlight value of each backlight block.

Based on this, the backlight data processing module 60 may use the memory 61 to store the backlight value of each backlight block corresponding to the information of each frame of to-be-displayed image, and use the operator 62 to obtain the transition backlight value of each backlight block based on the backlight values of each backlight block corresponding to the information of each two adjacent frames of to-be-displayed images and to store the obtained transition backlight value of each backlight block in the memory 61. Furthermore, the backlight data processing module 60 may output the data stored in the memory 61, that is, the memory 61 may output the obtained transition backlight value of each backlight block by inserting the transition backlight value of each backlight between the backlight values of the backlight block corresponding to the information of each two adjacent frames of to-be-displayed images. Thus, the transition backlight value of each backlight block may be used to reduce the difference between the backlight values of each backlight block corresponding to the information of two adjacent frames of to-be-displayed images.

In some examples, the memory 61 may be a random access memory (abbreviated as RAM), and the memory partitions of the memory 61 may be block RAMs (abbreviated as BRAMs), but the embodiments of the present disclosure are not limited thereto.

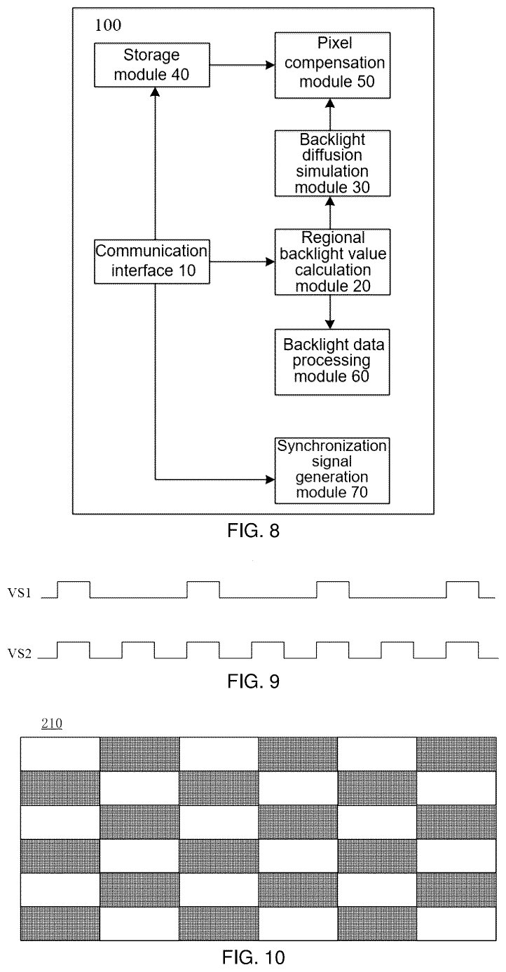

FIG. 8 is a structural diagram of an image display processing apparatus, in accordance with some embodiments.

In some embodiments, referring to FIGS. 2 and 8, the image display processing device 100 further includes a synchronization signal generation module 70. The synchronization signal generation module 70 is coupled between the communication interface 10 and the backlight module 220. The synchronization signal generation module 70 is configured to: obtain a first synchronization signal corresponding to the information of the to-be-displayed image based on the information of the to-be-displayed image from the communication interface 10, and obtain a second synchronization signal based on the first synchronization signal. In addition, after obtaining the second synchronization signal, the synchronization signal generation module 70 transmitting the second synchronization signal to the backlight module 220. The frequency of the second synchronization signal is greater than the frequency of the first synchronization signal, so that the backlight data processing module 60 outputs a transition backlight value of each backlight block between the backlight values of the backlight block corresponding to information of each two adjacent frames of to-be-displayed images.

The backlight module 220 may receive the second synchronization signal from the synchronization signal generation module 70, and receive the backlight value of each backlight block corresponding to the information of each two adjacent frames of to-be-displayed images and the corresponding transition backlight value of the backlight block that are from the backlight data processing module 60.

Furthermore, the backlight module 220 may read, under control of a first falling edge of the second synchronization signal, the backlight value of each backlight block corresponding to information of a first frame of to-be-displayed image, and emit light based on the backlight value of the backlight block corresponding to the information of the first frame of to-be-displayed image. The backlight module 220 may read, under control of a second falling edge of the second synchronization signal, the transition backlight value of each backlight block obtained by calculating an average of the backlight value of the backlight block corresponding to the information of the first frame of to-be-displayed image and the backlight value of the backlight block corresponding to the information of a second frame of to-be-displayed image, and emit light based on the transition backlight value of the backlight block. The backlight module 220 may read, under control of a third falling edge of the second synchronization signal, the backlight value of each backlight block corresponding to the information of the second frame of to-be-displayed image, and emit light based on the backlight value of each backlight block corresponding to the information of the second frame of to-be-displayed image. The backlight module 220 may read, under control of a fourth falling edge of the second synchronization signal, a transition backlight value of each backlight block obtained by calculating an average of the backlight value of the backlight block corresponding to the information of the second frame of to-be-displayed image and a backlight value of the backlight area corresponding to the information of a third frame of to-be-displayed image, and emit light based on the transition backlight value of the backlight block. The backlight module 220 may read, under control of a fifth falling edge of the second synchronization signal, the backlight value of the backlight block corresponding to the information of the third frame of to-be-displayed image, and emit light based on the backlight value of the backlight block corresponding to the information of the third frame of to-be-displayed image; and subsequently read is performed according to the above rules.

Furthermore, the frequency of the second synchronization signal is greater than the frequency of the first synchronization signal, and the frequency at which the backlight module reads information based on the second synchronization signal is greater than the frequency at which the regional backlight value calculation module 20 receives information of each frame of to-be-displayed image. Thus, during receiving information of two adjacent frames of to-be-displayed images, after receiving the backlight value of each backlight block corresponding to the information of the former frame of to-be-displayed image and before receiving the backlight value of the backlight block corresponding to the information of the latter frame of to-be-displayed image, the backlight module 220 may read the corresponding transition backlight value of the backlight block.

Based on this, the transition backlight value of each backlight block may be used to reduce the difference between the backlight values of the backlight block corresponding to the information of two adjacent frames of to-be-displayed images, thereby ameliorating the flicker problem and improving the display effect of the display panel 210.

In some embodiments, the first synchronization signal is a vertical synchronization signal. In some other embodiments, the second synchronization signal is a vertical synchronization signal.

FIG. 9 is a waveform diagram of a first synchronization signal and a second synchronization signal, in accordance with some embodiments.

In some embodiments, as shown in FIG. 9, the frequency of the second synchronization signal VS2 is 3 times the frequency of the first synchronization signal VS1.

As shown in FIG. 9, each falling edge in the first synchronization signal VS1 may represent a moment at which the regional backlight value calculation module 20 receiving information of a frame of to-be-displayed image. That is, in the first synchronization signal VS1, the first falling edge may represent a moment at which the regional backlight value calculation module 20 receives the information of the first frame of to-be-displayed image; in the first synchronization signal VS1, the second falling edge may represent a moment at which the regional backlight value calculation module 20 receives the information of the second frame of to-be-displayed image; and in the first synchronization signal VS1, the third falling edge may represent a moment at which the regional backlight value calculation module 20 receives the information of the third frame of to-be-displayed image; and the information of the other frames of to-be-displayed images is received in sequence according to the above rule.

Setting the frequency of the second synchronization signal VS2 to 3 times the frequency of the first synchronization signal VS1 is equivalent to adding a falling edge between every two falling edges of the first synchronization signal VS1.

Based on this, the backlight module 220 is controlled by the second synchronization signal VS2, which will not affect that the backlight module 220 emits light based on the backlight value of each backlight block corresponding to the information of each frame of to-be-displayed image, so that the time when the backlight module 220 obtains the backlight values of all the backlight blocks corresponding to the information of the n-th frame of to-be-displayed image is substantially the same as the time when the display panel 210 obtains the compensated pixel values of the n-th frame of to-be-displayed image. Therefore, it is possible to help improve the contrast of the display panel 210, and help improve the display effect of the display panel 210.

Specifically, the first falling edge of the second synchronization signal VS2 corresponds to the first falling edge of the first synchronization signal VS1, the backlight module 220 reads, under the control of the first falling edge of the second synchronization signal VS2, the backlight value of each backlight block corresponding to the information of the first frame of to-be-displayed image to emit light; and other modules may also obtain, under the control of the first falling edge of the first synchronization signal VS1, corresponding data according to the information of the first frame of to-be-displayed image, so that the display panel 210 may perform display. The third falling edge of the second synchronization signal VS2 corresponds to the second falling edge of the first synchronization signal VS1, the backlight module 220 reads, under the control of the third falling edge of the second synchronization signal VS2, the backlight value of each backlight block corresponding to the information of the second frame of to-be-displayed image; and other modules may also obtain, under the control of the second falling edge of the first synchronization signal VS1, corresponding data according to the information of the second frame of to-be-displayed image, so that the display panel 210 may perform display. Moreover, before reading the backlight value of each backlight block corresponding to the information of the second frame of to-be-displayed image for emitting light, the backlight module 220 may also read the transition backlight value of each backlight block obtained by calculating the average value of the backlight value of the backlight block corresponding to the information of the first frame of to-be-displayed image and the backlight value of the backlight block corresponding to the information of the second frame of to-be-displayed image to emit light.

Based on this, the frequency of the second synchronization signal VS2 is set to be 3 times the frequency of the first synchronization signal VS1. Thus, in a case where the backlight module 220 emits light normally corresponding to the display panel 210, the backlight value of each backlight block is used to emit light, and a smooth transition process is provided, which may help improve the display effect of the display panel 210 during dynamic display.

In some embodiments, as shown in FIGS. 2 and 8, description will be made by taking an example in which the memory 61 in the backlight data processing module 60 includes 5 memory partitions for storing backlight values.

The 5 memory partitions are a first memory partition, a second memory partition, a third memory partition, a fourth memory partition and a fifth memory partition.

When the backlight data processing module 60 receives the backlight value of each backlight block corresponding to the information of the first frame of to-be-displayed image from the regional backlight value calculation module 20, the backlight value of each backlight block corresponding to the information of the first frame of to-be-displayed image is stored in the first memory partition. Subsequently, the backlight module 220 may read the backlight value of each backlight block stored in the first memory partition to emit light under the control of the first falling edge of the second synchronization signal.

When the backlight data processing module 60 receives the backlight value of each backlight block corresponding to the information of the second frame of to-be-displayed image from the regional backlight value calculation module 20, the backlight value of each backlight block corresponding to the information of the second frame of to-be-displayed image is stored in the third memory partition. In addition, the backlight data processing module 60 may further obtain the corresponding transition backlight value of each backlight block based on the backlight value of each backlight block stored in the first memory partition (the backlight value of the backlight block corresponding to the information of the first frame of to-be-displayed image) and the backlight value of each backlight block stored in the third memory partition (the backlight value of each backlight block corresponding to the information of the second frame of to-be-displayed image), and store the transition backlight value of each backlight block in the second memory partition. Subsequently, the backlight module 220 may read, under the control of the second falling edge of the second synchronization signal, the transition backlight value of each backlight block stored in the second memory partition to emit light, and the backlight module 220 may read, under the control of the third falling edge of the second synchronization signal, the backlight value of each backlight block stored in the third memory partition to emit light.

When the backlight data processing module 60 receives the backlight values of each backlight block corresponding to the information of the third frame of to-be-displayed image from the regional backlight value calculation module 20, the backlight value of each backlight block corresponding to the information of the third frame of to-be-displayed image is stored in the fifth memory partition. In addition, the backlight data processing module 60 may also obtain the corresponding transition backlight value of each backlight block based on the backlight value of each backlight block stored in the third memory partition (the backlight value of each backlight block corresponding to the information of the second frame of to-be-displayed image) and the backlight value of each backlight block stored in the fifth memory partition (the backlight value of each backlight block corresponding to the information of the third frame of to-be-displayed image), and store the transition backlight value of each backlight block in the fourth memory partition. Subsequently, the backlight module 220 may read, under the control of the fourth falling edge of the second synchronization signal, the transition backlight value of each backlight block stored in the fourth memory partition to emit light, and the backlight module 220 may read, under the control of the fifth falling edge of the second synchronization signal, the backlight value of each backlight block stored in the fifth memory partition to emit light.

In this case, since the memory 61 only uses 5 memory partitions to store the backlight values, when the backlight data processing module 60 receives the backlight value of each backlight block corresponding to the information of the fourth frame of to-be-displayed image from the regional backlight value calculation module 20, the backlight value of each backlight block corresponding to the information of the fourth frame of to-be-displayed image is stored in the second memory partition subsequently. In addition, the backlight data processing module 60 may also obtain the corresponding transition backlight value of each backlight block based on the backlight value of each backlight block stored in the fifth memory partition (the backlight value of each backlight block corresponding to the information of the third frame of to-be-displayed image) and the backlight value of each backlight block stored in the second memory partition (the backlight value of each backlight block corresponding to the information of the fourth frame of to-be-displayed image), and store the transition backlight value of each backlight block in the first memory partition; and subsequently, the backlight module 220 may read, under the control of the fourth falling edge of the second synchronization signal, the transition backlight value of each backlight block stored in the first memory partition to emit light, and the backlight module 220 may read, under the control of the fifth falling edge of the second synchronization signal, the backlight value of each backlight block stored in the second memory partition to emit light. Subsequent store and read are performed according to the above rules.

Based on this, the memory 61 may be used to effectively separate and distinguish the backlight values of all the backlight block corresponding to the information of adjacent frames of to-be-displayed images, as well as the transition backlight values of the related backlight blocks, only using 5 memory partitions, so that the backlight module 220 may subsequently read the corresponding data accurately to prevent data confusion.

It will be noted that, in the above embodiment only be described by taking an example in which the memory 61 uses only 5 memory partitions to store backlight values (backlight values and transition backlight values) for calculation, but the embodiments of the present disclosure are not limited thereto. It can be understood that in some other embodiments, the memory 61 may use 6 memory partitions to store backlight values. The storage rule for the memory 61 to use 6 memory partitions to store the backlight value is similar to the above-mentioned description that the memory uses 5 memory partitions to store the backlight values, which will not be repeated here.

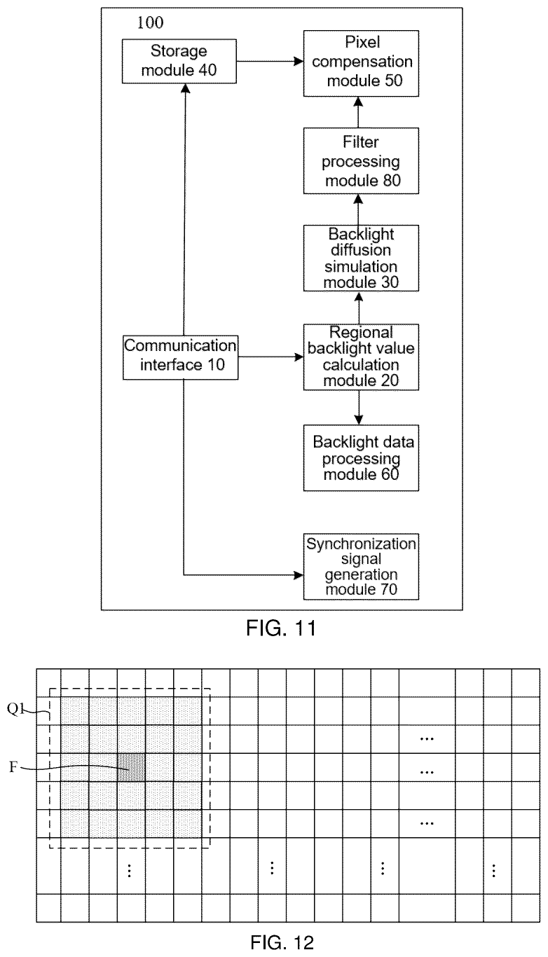

FIG. 10 is a diagram showing a display image of a display panel in a certain frame, in accordance with some other embodiments; FIG. 11 is a structural diagram of an image display processing apparatus, in accordance with some embodiments; and FIG. 12 is a structural diagram of a first matrix, in accordance with some embodiments.

Referring to FIGS. 2, 11 and 12, in some embodiments, the image display processing apparatus 100 further includes a filter processing module 80. The filter processing module 80 is coupled between the backlight diffusion simulation module 30 and the pixel compensation module 50. The filter processing module 80 is configured to receive the diffuse backlight value of each backlight block in each frame from the backlight diffusion simulation module 30, and the filtering processing module 80 is further configured to: select a target backlight block F from all the backlight blocks, the target backlight block F and multiple backlight blocks around the target backlight block F constituting a first matrix Q1 with n rows and n columns, and obtain an average diffuse backlight value of all backlight blocks in the first matrix based on the diffuse backlight values of all the backlight blocks in the first matrix Q1. In addition, the filter processing module 80 is further configured to transmit each average diffuse backlight value to the pixel compensation module 50. Subsequently, the pixel compensation module 50 may compensate the pixel values of the to-be-displayed image based on all the average diffuse backlight values and the information of the to-be-displayed image from the communication interface 10 to obtain compensated pixel values of the to-be-displayed image. N is a positive integer.

Based on this, multiple array-arranged backlight blocks may be combined into multiple first matrices Q1 to obtain the average diffuse backlight value corresponding to the first matrix Q1, so that the average diffuse backlight value corresponding to multiple backlight block within a region may be obtained. That is, the backlight values corresponding to all backlight blocks in the first matrix Q1 may be added to calculate an average value, so as to obtain a corresponding average diffuse backlight value. Thus, the difference between the average diffuse backlight values corresponding to adjacent first matrices Q1 may be made small, so that the average diffuse backlight values corresponding to adjacent first matrices Q1 transition smoothly, which may help to ameliorate the problem of patchy stripes and improve the display effect of the display panel 210.

The “the first matrix Q1 with n rows and n columns consisted of the target backlight block F and multiple backlight blocks around the target backlight block F” includes a row of backlight blocks including the target backlight block F and (n-1) rows of backlight blocks adjacent thereto in a row direction and a column of backlight blocks including the target backlight block F and (n−1) columns of backlight blocks adjacent thereto in a column direction.

In some examples, referring to FIG. 12, the first matrix Q1 is symmetrically arranged with the target backlight block F as the center. With such configuration, the number of backlight blocks on two sides, in the row direction, of the target backlight block F in the first matrix Q1 may be made consistent, and the number of backlight blocks on two sides, in the column direction, of the target backlight block F in the first matrix Q1 may be made consistent. In this way, the number of backlight blocks immediately around the target backlight block in all directions (up, down, left, and right) may be made consistent, so as to reduce the difference between the backlight values of the backlight blocks immediately around the target backlight block in all directions (up, down, left, and right), which is beneficial for reducing the difference between the average diffused backlight values corresponding to adjacent first matrices Q1, so that the average diffused backlight values corresponding to adjacent first matrices Q1 transition smoothly. As a result, it may be possible to help improve the generation of patch stripes to improve the display effect of the display panel 210.

In some embodiments, referring to FIG. 12, the first matrix Q1 may be a 5×5 matrix, where n=5. That is, 25 backlight blocks arranged in an array are consisting of a plurality of first matrices Q1.

In this way, the number of backlight blocks for consisting of a first matrix Q1 will not be too small, which is beneficial for making the average diffused backlight values corresponding to adjacent first matrices Q1 smooth, thereby reducing the generation of patch stripes, and improving the display effect of the display panel 210. Furthermore, the number of backlight blocks for consisting of a first matrix Q1 may be kept small, thereby reducing the computational load of the filter processing module 80 and improving the working efficiency of the filter processing module 80 to prevent the display effect of the display panel 210 from being affected. However, the present disclosure is not limited the above. For example, in some other embodiments, the first matrix Q1 may be a 7×7 matrix.

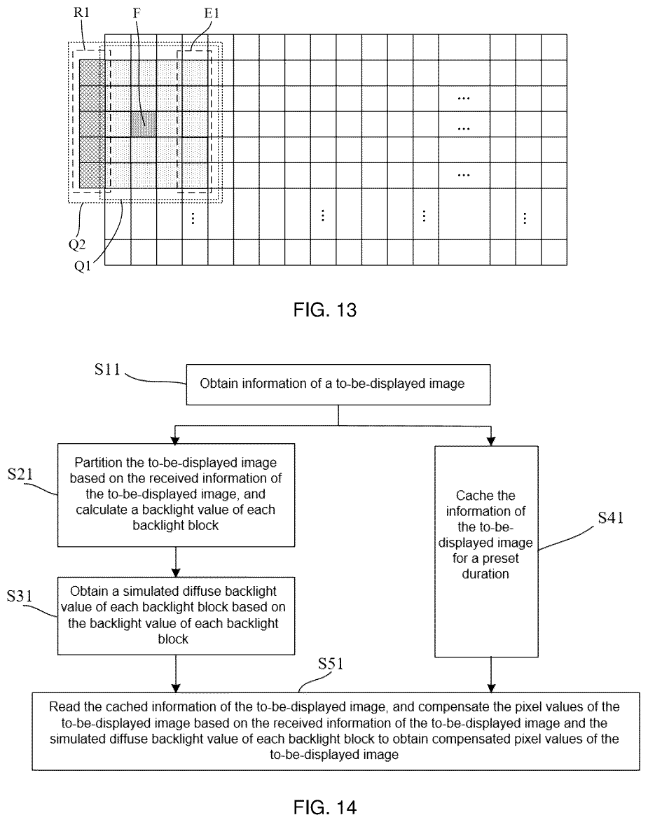

FIG. 13 is a structural diagram of a second matrix, in accordance with some embodiments.

In some embodiments, referring to FIGS. 12 and 13, the filter processing module 80 in the image display processing apparatus 100 is further configured to, in a case where the first matrix Q1 is not symmetrically arranged with the target backlight block F as the center, the first matrix Q1 is supplemented with backlight blocks in a mirror manner to form a second matrix Q2 symmetrically arranged with the target backlight block F as the center.

FIG. 12 is used as an example for description: in the first matrix Q1, there are a first column of backlight blocks and a second column of backlight blocks on the left side of the target backlight block F, and the second column of backlight blocks is located between the first column of backlight blocks and the target backlight block F; there are four column of backlight blocks and a fifth column of backlight blocks on the right side of the target backlight block, and the fourth column of backlight blocks is located between the target backlight block F and the fifth column of backlight blocks; there are a first row of backlight blocks and a second row of backlight blocks above the target backlight block F, and the second row of backlight blocks is located between the first row of backlight blocks and the target backlight block F; and there are a fourth row of backlight blocks and a fifth row of backlight blocks below the target backlight block F, and the fourth row of backlight blocks is located between the target backlight block F and the fifth row of backlight blocks.

FIG. 13 is taken as an example for introduction: in the first matrix Q1, there is only one column of backlight blocks on the left side of the target backlight block F. Compared with the first matrix Q1 shown in FIG. 12, the first column of backlight blocks is missing, resulting in the first matrix shown in FIG. 13 not being symmetrically arranged with the target backlight block F as the center. In this case, a virtual first column of backlight blocks R1 is created to be enable the virtual first column of backlight blocks R1 and the fifth column of backlight blocks E1 in the first matrix Q1 is mirror symmetrical with respect to the target backlight block F. The virtual first column of backlight blocks R1 created based on the mirror symmetry of the fifth column of backlight blocks E1 and the first matrix Q1 are combined into a second matrix Q2. In this case, the second matrix Q2 is a matrix symmetrically arranged with the target backlight block F as the center.

Based on this, the average diffuse backlight value of all the backlight blocks in the second matrix Q2 may be obtained based on the diffuse backlight values of all the backlight blocks in the second matrix Q2, and the obtained average diffuse backlight value may be used as the average diffuse backlight value of the first matrix Q1 in the second matrix Q2. Subsequently, the filter processing module 80 transmits the obtained average diffuse backlight value corresponding to the first matrix Q1 to the pixel compensation module 50. Thus, the average diffused backlight values corresponding to adjacent first matrices Q1 transition smoothly, which may be beneficial for reducing the generation of patch stripes and improving the display effect of the display panel 210.

FIG. 14 is a flow diagram of an image display processing method, in accordance with some embodiments.

In some embodiments, as shown in FIG. 14, an image display method is provided, and the method includes the following steps.

In S11, information of a to-be-displayed image is obtained. The to-be-displayed image is an image that the display panel currently needs to display, and the information of the to-be-displayed image may include a resolution of the to-be-displayed image, and image three-channel values of each pixel.

In S21, the to-be-displayed image is partitioned based on the received information of the to-be-displayed image, and a backlight value of each backlight block is calculated. Step S21 may include the following steps.

In S211, the to-be-displayed image is partitioned based on the received information of the to-be-displayed image to obtain information of multiple image blocks.

In S212, a backlight value of a corresponding backlight block is calculated based on the information of an image block of the to-be-displayed image to obtain the backlight value of each backlight block. The number of pieces of information of the image blocks corresponds to the number of backlight blocks in a one-to-one manner; that is, information of one image block corresponds to the backlight value of one backlight block.

Based on this, the regional backlight value calculation module 20 may obtain the backlight value of the corresponding backlight block based on the information of different blocks of the to-be-displayed image, so that the backlight value of each backlight block may be used for driving separately.

In S31, based on the backlight value of each backlight block, a simulated diffuse backlight value of each backlight block is obtained.

The light emitted from any backlight block will illuminate an adjacent backlight block, and various positions in the same backlight block are affected differently by the light diffusion of the adjacent backlight block.

Based on this, the actual backlight situation is simulated in the step S31, thereby ameliorating the effect of light diffusion on the light emitted by the multiple backlight blocks of the backlight module 220 to alleviate the blocking phenomenon.

In S41, the information of the to-be-displayed image is cached for a preset duration.

In the step S41, after receiving the information of the to-be-displayed image, the information to be stored is cached for a certain duration before being transmitted. Specifically, the cache duration may be substantially equal to a duration for the regional backlight value calculation module to partition the to-be-displayed image and to calculate the backlight value of each backlight block.

In S51, the cached information of the to-be-displayed image is read, and pixel values of the to-be-displayed image are compensated based on the received information of the to-be-displayed image and the simulated diffuse backlight value of each backlight block to obtain compensated pixel values of the to-be-displayed image.

In step S51, the cached information of the to-be-displayed image transmitted in step S41 is received, and the simulated diffuse backlight value of each backlight block obtained in step S31 is received. Moreover, based on the information of the to-be-displayed image and the simulated diffuse backlight value of each backlight block, the pixel values of the to-be-displayed image are compensated to obtain compensated pixel values of the to-be-displayed image.

Since it takes a certain duration to calculate the backlight values of all the backlight blocks in step S21, receiving the signals in corresponding steps S31 and S51 will be delayed for a certain duration. In this case, the information of the to-be-displayed image may be cached for a preset duration by using step S41, so as to compensate for the duration required for calculating the backlight value of each backlight block in step S21 by using the preset duration. Based on this, in the image display processing method, the backlight values of all the backlight blocks corresponding to the n-th frame of to-be-displayed image and the compensated pixel values of the n-th frame of to-be-displayed image may be output substantially at the same time. Furthermore, when the image display processing method is applied to a display apparatus, the time when the backlight module obtains the backlight values of all the backlight blocks corresponding to the n-th frame of to-be-displayed image output based on step S21 is substantially the same as the time when the display panel obtains the compensated pixel values of the n-th frame of to-be-displayed image output based on step S51. Based on this, the contrast of the display panel may be improved, which is beneficial to improving the display effect of the display panel.

In summary, in the image display processing method provided in some embodiments of the present disclosure, step S41 is used to cache the information of the to-be-displayed image, so as to use the cache duration to compensate for the duration required to calculate the backlight values of all the backlight blocks in step S21. Based on this, in the image display processing method, the backlight values of all the backlight blocks corresponding to the n-th frame of to-be-displayed image and the compensated pixel values of the n-th frame of to-be-displayed image may be output substantially at the same time, so as to ameliorate the problem that the backlight values of all the backlight blocks corresponding to the n-th frame of to-be-displayed image and the compensated pixel values of the n-th frame of to-be-displayed image cannot be simultaneously output due to a fact that calculating the backlight values of all the backlight blocks in step S21 requires a certain duration. Based on this, the display panel and the backlight module receive the required signals simultaneously to perform light-emitting display, which is beneficial to improving the contrast of the display panel and improving the display effect of the display panel.

In some examples, referring to FIG. 14, the preset duration for caching the information of the to-be-displayed image in step S41 is substantially equal to the duration for partitioning the to-be-displayed image and calculating the backlight values of all the backlight blocks in step S21.

Based on this, the information of the to-be-displayed image may be cached for a preset duration by using step S41, so as to compensate for the duration required for calculating the backlight values of all the backlight blocks in step S21 by using the preset duration. Thus, the time when the backlight values of all the backlight blocks corresponding to the n-th frame of to-be-displayed image outputted in step S21 are received in step S51 may be made substantially the same as the time when the information of the n-th frame of to-be-displayed image outputted in step S41 is received, and the time when step S51 outputs the compensated pixel values of the n-th frame of to-be-displayed may be made substantially the same as the time when step S21 outputs the backlight values of all the backlight blocks corresponding to the n-th frame of to-be-displayed image. Therefore, the problem of inconsistency between the time of outputting the compensated pixel values of the n-th frame of to-be-displayed image and the time of outputting the backlight values of all the backlight blocks corresponding to the n-th frame of to-be-displayed image may be ameliorated. Furthermore, when the image display processing method is applied to a display apparatus, the display panel and the backlight module can simultaneously receive the required signals for light-emitting display, which is beneficial to improving the contrast of the display panel and improving the display effect of the display panel.

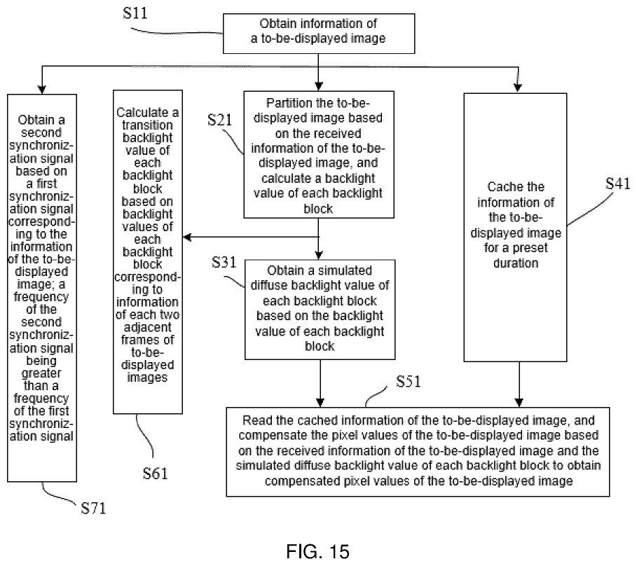

FIG. 15 is a flow diagram of an image display processing method, in accordance with some embodiments.

In some embodiments, with continued reference to FIG. 15, the image display processing method further includes the following.

In S61, a transition backlight value of each backlight block is calculated based on backlight values of each backlight block corresponding to information of each two adjacent frames of to-be-displayed images.

After obtaining the backlight value of each backlight block of each frame in step S21, step S61 may be used to receive the backlight value of each backlight block of each frame, and to calculate the transition backlight value of each backlight block based on the backlight values of each backlight block corresponding to the information of each two adjacent frames of to-be-displayed images. Subsequently, the transition backlight value of each backlight block may be outputted by inserting the transition backlight value of each backlight block between the backlight values of each backlight block corresponding to the information of each two adjacent frames of to-be-displayed images, so as to utilize the transition backlight value of each backlight block to reduce the difference between the backlight values of the corresponding backlight block corresponding to the information of the two adjacent frames of to-be-displayed images.

Based on this, in a case where the image display processing method is applied to a display apparatus, and the display panel 210 performs dynamic display, the backlight module 220 may sequentially read the backlight value of each backlight block corresponding to the information of the former frame of to-be-displayed image, the transition backlight value of each backlight block, and the backlight value of each backlight block corresponding to the information of the latter frame of to-be-displayed image to emit light, which may help reduce the problem of backlight flickering caused by the great brightness difference between two adjacent frames when the display panel 210 performs dynamic display, thereby improving the display effect of the display panel 210.

In some embodiments, with continued reference to FIG. 15, the image display processing method further includes the following.

In S71, a second synchronization signal is obtained based on a first synchronization signal corresponding to the information of the to-be-displayed image; the frequency of the second synchronization signal is greater than the frequency of the first synchronization signal, so as to output the transition backlight value of each backlight block between the backlight values of each backlight block corresponding to the information of each two adjacent frames of to-be-displayed images.

After obtaining the information of the to-be-displayed image in step S11, step S71 may be used to receive the information of the to-be-displayed image, obtain the first synchronization signal corresponding to the information of the to-be-displayed image, and obtain the second synchronization signal based on the first synchronization signal.

In the image display processing method, in step S61, the transition backlight value of each backlight block may be output by inserting the transition backlight value of each backlight block between the backlight values of each backlight block corresponding to the information of each two adjacent frames of to-be-displayed images; and in step S71, the second synchronization signal may be output.

Based on this, in the case where the image display processing method is applied to a display apparatus, the backlight module of the display apparatus may sequentially read, under the control of the second synchronization signal, the backlight value of each backlight block corresponding to the information of the former frame of to-be-displayed image in each two adjacent frames of to-be-displayed images, the transition backlight value of each backlight block, and the backlight value of each backlight block corresponding to the information of the latter frame of to-be-displayed image in the each two adjacent frames of to-be-displayed images. That is, during receiving information of two adjacent frames of to-be-displayed images, the backlight module may read the transition backlight value corresponding to each backlight block after receiving the backlight value of each backlight block corresponding to the information of the former frame of to-be-displayed image and before receiving the backlight value of each backlight block corresponding to the information of the latter frame of to-be-displayed image. Thus, the transition backlight value of each backlight block may be used to reduce the difference between the backlight values of each backlight block corresponding to the information of the two adjacent frames of to-be-displayed images, thereby ameliorating the flicker problem and improving the display effect of the display panel.

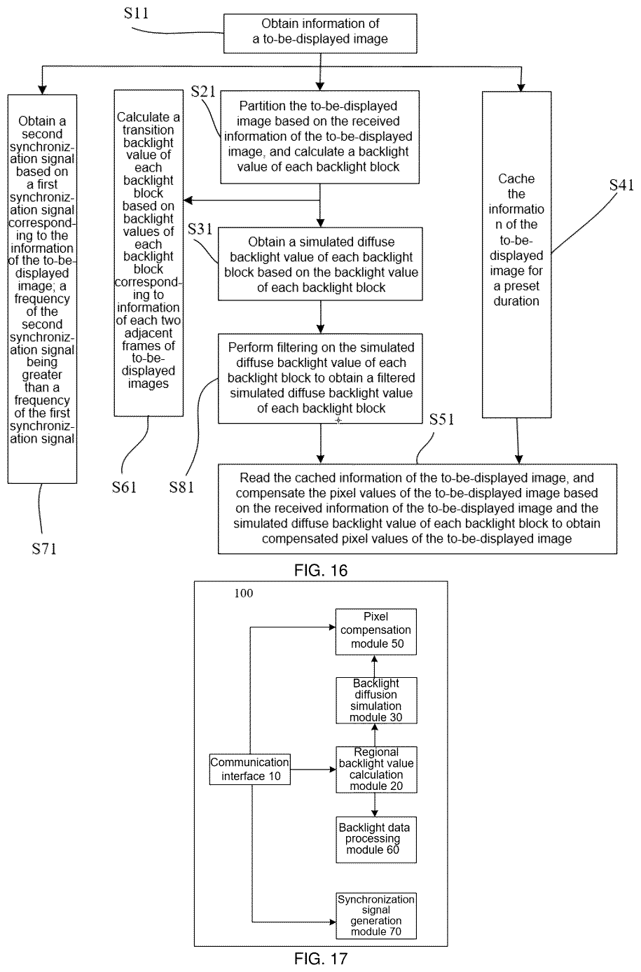

FIG. 16 is a flow diagram of an image display processing method, in accordance with some embodiments.

In some embodiments, as shown in FIG. 16, the image display processing method further includes the following steps.

In S81, filtering is performed on the simulated diffuse backlight value of each backlight block to obtain a filtering simulated diffuse backlight value of each backlight block.

After step S31 and before step S51, step S81 may be used to perform filtering on the simulated diffuse backlight value of each backlight block obtained in step S31 to obtain a filtered simulated diffuse backlight value of each backlight block.

Based on this, step S51 may include: compensating pixel values of the to-be-displayed image according to the filtered simulated diffuse backlight values of all the backlight blocks and the read cached information of the to-be-displayed image, so as to obtain compensated pixel values of the to-be-displayed image.

Step S81 may be used to obtain the filtered simulated diffuse backlight value of each backlight block to reduce the difference in the filtered simulated diffuse backlight values of adjacent backlight blocks, thereby making the filtered simulated diffuse backlight values of adjacent backlight block transition smoothly, which may help reduce the generation of patch stripes and improve the display effect of the display panel 210.

In some embodiments, with continued reference to FIG. 16, performing filtering in the step S81 includes:
S811a, selecting a target backlight block from all the backlight blocks, the target backlight block and multiple backlight blocks around the target backlight block constituting a first matrix with n rows and n columns; and
S812a, obtaining, based on the diffuse backlight value of each backlight block in the first matrix, an average diffuse backlight value of each backlight block in the first matrix, where n is a positive integer.

Based on this, multiple array-arranged backlight blocks may be combined into multiple first matrices to obtain the average diffuse backlight value corresponding to the first matrix, so that the average diffuse backlight value corresponding to multiple backlight block within a region may be obtained. That is, the backlight values corresponding to all the backlight blocks in the first matrix may be added to obtain an average value, so as to obtain a corresponding average diffuse backlight value. Thus, the difference between the average diffuse backlight values corresponding to adjacent first matrices may be made small, so that the average diffuse backlight values corresponding to adjacent first matrices transition smoothly, which may help to ameliorate the problem of patchy stripes and improve the display effect of the display panel.

In some examples, the target backlight block and multiple backlight blocks around the target backlight block constitute a first matrix, which is a matrix symmetrically arranged with the target backlight block as the center.

The first matrix is symmetrically arranged with the target backlight block as the center. With such configuration, the number of backlight blocks on two sides, in the row direction, of the target backlight block in the first matrix may be made consistent, and the number of backlight blocks on two sides, in the column direction, of the target backlight block in the first matrix may be made consistent. In this way, the number of backlight blocks immediately around the target backlight block in all directions (up, down, left, and right) may be made consistent, so as to reduce the difference between the backlight values of the backlight blocks immediately around the target backlight block in all directions (up, down, left, and right), which is beneficial for reducing the difference between the average diffused backlight values corresponding to adjacent first matrices, so that the average diffused backlight values corresponding to adjacent first matrices transition smoothly. As a result, it may be possible to help improve the generation of patch stripes to improve the display effect of the display panel.

In some examples, the target backlight block and multiple backlight blocks around the target backlight block constitute a first matrix, which is not symmetrically arranged with the target backlight block F as the center. Performing filtering in step S81 includes:
S811b, selecting a target backlight block from all the backlight blocks, the target backlight block and multiple backlight blocks around the target backlight block constituting a first matrix with n rows and n columns;
S812b, supplementing the first matrix with backlight blocks in a mirror manner to form a second matrix that is symmetrically arranged with the target backlight block as the center; and
S813b, obtaining, based on diffuse backlight values of all backlight blocks in the second matrix, an average diffuse backlight value of all the backlight blocks in the second matrix, where n is a positive integer.

Based on this, the average diffuse backlight value of all the backlight blocks in the second matrix may be obtained based on the diffuse backlight values of all the backlight blocks in the second matrix, and the obtained average diffuse backlight value may be used as the average diffuse backlight value of the first matrix in the second matrix. Subsequently, in step S51, the pixel values of the to-be-displayed image are compensated based on the obtained average diffuse backlight value corresponding to the first matrix and the read cached information of the to-be-displayed image to obtain the compensated pixel values of the to-be-displayed image. With such an arrangement, the average diffused backlight values corresponding to adjacent matrices transition smooth, which may be beneficial to reducing the generation of patch stripes and improving the display effect of the display panel 210.

It will be noted that the above-mentioned image display processing method may be applied to the image display processing apparatus 100 shown in FIG. 11. For the detailed description of each of the above steps, the reference will be made to the description of the image display processing apparatus 100 shown in FIG. 11, which will not be repeated here.

FIG. 17 is a structural diagram of an image display processing apparatus, in accordance with some other embodiments.

In light of this, some embodiments of the present disclosure provide an image display processing apparatus 100. Referring to FIG. 17, the image display processing apparatus 100 includes a communication interface 10, a regional backlight value calculation module 20, a backlight data processing module 60, a synchronization signal generation module 70, a backlight diffusion simulation module 30, and a pixel compensation module 50.

The communication interface is configured to receive information of a to-be-displayed image; and the communication interface 10 is coupled to both the regional backlight value calculation module 20 and the synchronization signal generation module 70. The communication interface 10 is configured to receive the information of the to-be-displayed image, and transmit the information of the to-be-displayed image to the regional backlight value calculation module 20 and the synchronization signal generation module 70.

The regional backlight value calculation module 20 is coupled to the communication interface 10. The regional backlight value calculation module 20 is configured to partition the to-be-displayed image based on the received information of the to-be-displayed image, and calculate the backlight value of each backlight block.

The backlight data processing module 60 is coupled to the regional backlight value calculation module 20, and the backlight data processing module 60 is configured to calculate a transition backlight value of each backlight block based on backlight values of each backlight block corresponding to information of each two adjacent frames of to-be-displayed images.

Based on this, the backlight data processing module 60 may store the backlight value of each backlight block corresponding to the information of each frame of to-be-displayed image, and obtain the transition backlight value of each backlight block based on the backlight values of all the backlight blocks corresponding to the information of each two frames of to-be-displayed images. Furthermore, the backlight data processing module 60 may output the obtained transition backlight value of each backlight block by inserting the transition backlight value between the backlight values of each backlight block corresponding to the information of each two adjacent frames of to-be-displayed images, so as to use the transition backlight value of each backlight block to reduce the difference between the backlight values of each backlight block corresponding to the information of two adjacent frames of to-be-displayed image.

Furthermore, in the case where the backlight data processing module 60 is used to output the transition backlight value of each backlight block, by inserting the transition backlight value of each backlight block between the backlight values of each backlight block corresponding to information of each two adjacent frames of to-be-displayed images, to the backlight module 220, and the display panel 210 performs dynamic display, the backlight module 220 may sequentially read the backlight value of each backlight block corresponding to the information of the former frame of to-be-displayed image, the transition backlight value of each backlight block, and the backlight value of each backlight block corresponding to the information of the latter frame of to-be-displayed image to emit light, which may help reduce the problem of backlight flickering caused by the great brightness difference between two adjacent frames when the display panel 210 performs dynamic display, thereby improving the display effect of the display panel 210.

The synchronization signal generation module 70 is coupled to the communication interface 10, and the synchronization signal generation module 70 is configured to obtain a second synchronization signal based on a first synchronization signal corresponding to the information of the to-be-displayed image; the frequency of the second synchronization signal is greater than the frequency of the first synchronization signal, so that the backlight data processing module 60 output the transition backlight value of each backlight block between the backlight values of each backlight block corresponding to the information of each two adjacent frames of to-be-displayed images.

The backlight module 220 may receive the second synchronization signal from the synchronization signal generation module 70, and receive the backlight values of each backlight block corresponding to information of each two adjacent frames of to-be-displayed images and the corresponding transition backlight value of each backlight block from the backlight data processing module 60.

Furthermore, the backlight module 220 may read, under control of a first falling edge of the second synchronization signal, the backlight value of each backlight block corresponding to a first frame of information of the to-be-displayed image, and emit light based on the backlight value of each backlight block corresponding to the information of the first frame of to-be-displayed image. The backlight module 220 may read, under control of the second falling edge of the second synchronization signal, the transition backlight value of each backlight block obtained by calculating an average value of the backlight value of each backlight block corresponding to the information of the first frame of to-be-displayed image and the backlight value of each backlight block corresponding to the information of the second frame of to-be-displayed image, and emit light based on the transition backlight values of all the backlight blocks. The backlight module 220 may read, under control of a third falling edge of the second synchronization signal, the backlight value of each backlight block corresponding to the information of the second frame of to-be-displayed image, and emit light based on the backlight value of each backlight block corresponding to the information of the second frame of to-be-displayed image. The backlight module 220 may read, under control of a fourth falling edge of the second synchronization signal, the transition backlight value of each backlight block obtained by calculating an average value of the backlight value of each backlight block corresponding to the information of the second frame of to-be-displayed image and the backlight value of each backlight block corresponding to the information of a third frame of to-be-displayed image, and emit light based on the transition backlight value of each backlight block. The backlight module 220 may read, under control of a fifth falling edge of the second synchronization signal, the backlight value of each backlight block corresponding to the information of the third frame of to-be-displayed image, and emit light based on the backlight value of each backlight block corresponding to the information of the third frame of to-be-displayed image. Subsequent read is performed according to the above rules.

Furthermore, the frequency of the second synchronization signal is greater than the frequency of the first synchronization signal, and the frequency at which the backlight module reads information based on the second synchronization signal is greater than the frequency at which the regional backlight value calculation module 20 receives information of each frame of to-be-displayed image. Thus, during receiving information of two adjacent frames of to-be-displayed images, the backlight module 200 may read the transition backlight value corresponding to each backlight block after receiving the backlight value of each backlight block corresponding to the information of the former frame of to-be-displayed image and before receiving the backlight value of each backlight block corresponding to the information of the latter frame of to-be-displayed image.

Based on this, the transition backlight value of each backlight block may be used to reduce the difference between the backlight values of each backlight block corresponding to information of two adjacent frames of to-be-displayed images, thereby ameliorating the flicker problem and improving the display effect of the display panel 210.

The backlight diffusion simulation module 30 is coupled to the regional backlight value calculation module 20. The backlight diffusion simulation module 30 is configured to obtain a simulated diffuse backlight value of each backlight block based on the backlight value of each backlight block.

The pixel compensation module 50 is coupled to both the communication interface 10 and the backlight diffusion simulation module 30; the pixel compensation module 50 is configured to compensate pixel values of the to-be-displayed image based on the received information of the to-be-displayed image and the simulated diffuse backlight values of each backlight block to obtain the compensated pixel values of the to-be-displayed image.

To sum up, in the image display processing apparatus 100 provided in the embodiments of the present disclosure, the backlight data processing module 60 cooperates with the synchronization signal generation module 70 to increase the refresh frequency of the second synchronization signal generated by the synchronization signal generation module 70, so that the backlight data processing module 60 outputs the transition backlight value of each backlight block between the backlight values of each backlight block corresponding to information of each two adjacent frames of to-be-displayed images. Thus, in the case where the backlight module 220 emits light based on the backlight value of each backlight block corresponding to the information of each frame of to-be-displayed image, the corresponding transition backlight value of each backlight block may be inserted between the backlight values of each backlight block corresponding to information of two adjacent frames of to-be-displayed images, which may help reduce the difference between the backlight values of each backlight block corresponding to information of two adjacent frames of to-be-displayed images, thereby ameliorating the flickering problem of the display panel 210.

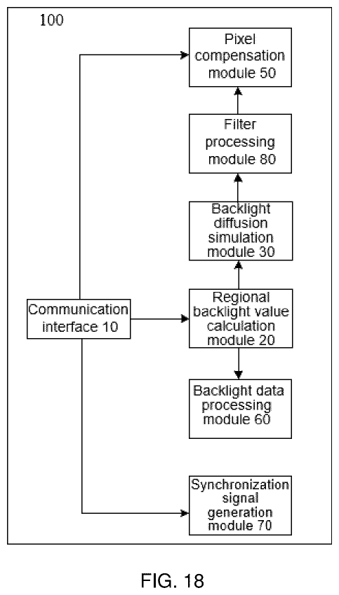

FIG. 18 is a structural diagram of an image display processing apparatus, in accordance with some other embodiments.

In some embodiments, as shown in FIG. 18, the image display processing apparatus 100 may further include a filter processing module 80. That is, the image display processing apparatus 100 includes a communication interface 10, a regional backlight value calculation module 20, a backlight data processing module 60, a synchronization signal generation module 70, a backlight diffusion simulation module 30, a filter processing module 80, and a pixel compensation module 50.

The filter processing module 80 is coupled between the backlight diffusion simulation module 30 and the pixel compensation module 50. The filter processing module 80 is configured to: select a target backlight block from all the backlight blocks, the target backlight block and multiple backlight blocks around the target backlight block constituting a first matrix of n rows and n columns, and the first matrix being symmetrically arranged with the target backlight block as the center; and obtain an average diffuse backlight value of all the backlight blocks in the first matrix based on the diffuse backlight values of all the backlight blocks in the first matrix, where n is a positive integer.

Based on this, multiple array-arranged backlight blocks may be combined into multiple first matrices Q1 to obtain the average diffuse backlight value corresponding to the first matrix Q1, so that the average diffuse backlight value corresponding to multiple backlight block within a region may be obtained. That is, the backlight values corresponding to all backlight blocks in the first matrix Q1 may be added to calculate an average value, so as to obtain a corresponding average diffuse backlight value. Thus, the difference between the average diffuse backlight values corresponding to adjacent first matrices Q1 may be made small, so that the average diffuse backlight values corresponding to adjacent first matrices Q1 transition smoothly, which may help to ameliorate the problem of patchy stripes and improve the display effect of the display panel 210.

It will be noted that, for the specific working principles and processes of the communication interface 10, the regional backlight value calculation module 20, the backlight data processing module 60, the synchronization signal generation module 70, the backlight diffusion simulation module 30, the filter processing module 80, and the pixel compensation module 50, reference will be made for the description in the above embodiments, which will not be repeated here.

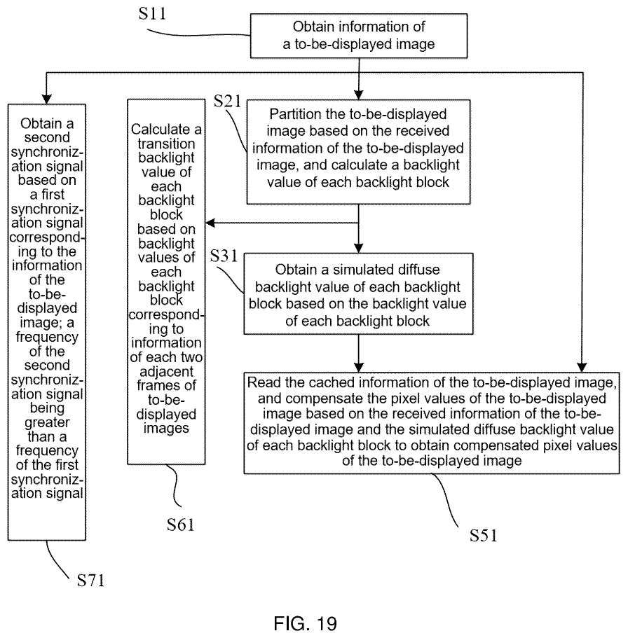

FIG. 19 is a flow diagram of an image display processing method, in accordance with some embodiments.

In some embodiments, as shown in FIG. 19, an image display processing method is provided, and the method includes the following steps.

In S11, information of a to-be-displayed image is obtained. The to-be-displayed image is an image that the display panel currently needs to display, and the information of the to-be-displayed image may include a resolution of the to-be-displayed image, and image three-channel values of each pixel.

In S21, the to-be-displayed image is partitioned based on the received information of the to-be-displayed image, and a backlight value of each backlight block is calculated. Step S21 may include the following steps.

In S211, the to-be-displayed image is partitioned based on the received information of the to-be-displayed image to obtain information of multiple image blocks.

In S212, a backlight value of a corresponding backlight block is calculated based on the information of an image block of the to-be-displayed image to obtain the backlight value of each backlight block. The number of pieces of information of the image blocks corresponds to the number of backlight blocks in a one-to-one manner; that is, information of one image block corresponds to the backlight value of one backlight block.

Based on this, the regional backlight value calculation module 20 may obtain the backlight value of the corresponding backlight block based on the information of different partitions of the to-be-displayed image, so that the backlight value of each backlight block may be used for driving separately.

In S61, a transition backlight value of each backlight block is calculated based on the backlight values of each backlight block corresponding to information of each two adjacent frames of to-be-displayed images.

After obtaining the backlight value of each backlight block of each frame in step S21, step S61 may be used to receive the backlight value of each backlight block of each frame, and calculate the transition backlight value of each backlight block based on the backlight values of each backlight block corresponding to the information of each two adjacent frames of to-be-displayed images. Subsequently, the transition backlight value of each backlight block may be outputted between the backlight values of each backlight block corresponding to the information of each two adjacent frames of to-be-displayed images, so as to utilize the transition backlight value of each backlight block to reduce the difference between the backlight values of each backlight block corresponding to the information of the corresponding two adjacent frames of to-be-displayed images.

Based on this, in the case where the image display processing method is applied to the display apparatus, and the display panel 210 performs dynamic display, the backlight module 220 may sequentially read the backlight value of each backlight block corresponding to the information of the former frame of to-be-displayed image, the transition backlight value of each backlight block, and the backlight value of each backlight block corresponding to the information of the latter frame of to-be-displayed image to emit light, which may help reduce the problem of backlight flickering caused by the great brightness difference between two adjacent frames when the display panel 210 performs dynamic display, thereby improving the display effect of the display panel 210.

In S71, a second synchronization signal is obtained based on the first synchronization signal corresponding to the information of the to-be-displayed image; the frequency of the second synchronization signal is greater than the frequency of the first synchronization signal, so as to output the transition backlight value of each backlight block between the backlight values of each backlight block corresponding to information of each two adjacent frames of to-be-displayed images.

After obtaining the information of the to-be-displayed image in step S11, step S71 may be used to receive the information of the to-be-displayed image, obtain the first synchronization signal corresponding to the information of the to-be-displayed image, and obtain the second synchronization signal based on the first synchronization signal.

In the image display processing method, the transition backlight value of each backlight block may be output between the backlight values of each backlight block corresponding to the information of each two adjacent frames of to-be-displayed images in step S61, and the second synchronization signal is output in step S71.

Based on this, in the case where the image display processing method is applied to the display apparatus, the backlight module of the display apparatus may sequentially read, under the control of the second synchronization signal, the backlight value of each backlight block corresponding to the information of the former frame of to-be-displayed image in each two adjacent frames, the transition backlight value of each backlight block, and the backlight value of each backlight block corresponding to the information of the latter frame of to-be-displayed image in the two adjacent frames. That is, during receiving information of two adjacent frames of to-be-displayed images, the backlight module may read the corresponding transition backlight value of each backlight block after receiving the backlight value of the backlight block corresponding to the information of the former frame of to-be-displayed image and before receiving the backlight value of the backlight block corresponding to the information of the latter frame of to-be-displayed image. Furthermore, the transition backlight value of each backlight block may be used to reduce the difference between the backlight values of each backlight block corresponding to the information of two adjacent frames of to-be-displayed images, thereby ameliorating the flicker problem and improving the display effect of the display panel.

In S31, a simulated diffuse backlight value of each backlight block is obtained based on the backlight value of each backlight block.

The light emitted from any backlight block will illuminate an adjacent backlight block, and various positions in the same backlight block are affected differently by the light diffusion of the adjacent backlight block.

Based on this, the actual backlight situation is simulated in step S31, thereby ameliorating the effect of light diffusion on the light emitted by the multiple backlight blocks of the backlight module 220 to alleviate the blocking phenomenon.

In S51, based on the received information of the to-be-displayed image and the simulated diffuse backlight value of each backlight block, the pixel values of the to-be-displayed image are compensated to obtain the compensated pixel values of the to-be-displayed image.

To sum up, in the image display processing method provided in some embodiments of the present disclosure, step S61 cooperates with step S71 to increase the refresh frequency of the second synchronization signal, so as to output a transition backlight value of each backlight block between the backlight values of each backlight block corresponding to the information of each two adjacent frames of to-be-displayed images. Thus, in the case where the image display processing method is applied to the image display processing apparatus of the display apparatus, and the backlight module emits light based on the backlight value of each backlight block corresponding to information of each frame of to-be-displayed image, the corresponding transition backlight value of each backlight block may be inserted between the backlight values of each backlight block corresponding to information of two adjacent frames of to-be-displayed images, which may help reduce the difference between the backlight values of each backlight block corresponding to information of two adjacent frames of to-be-displayed images, thereby ameliorating the flickering problem of the display panel.

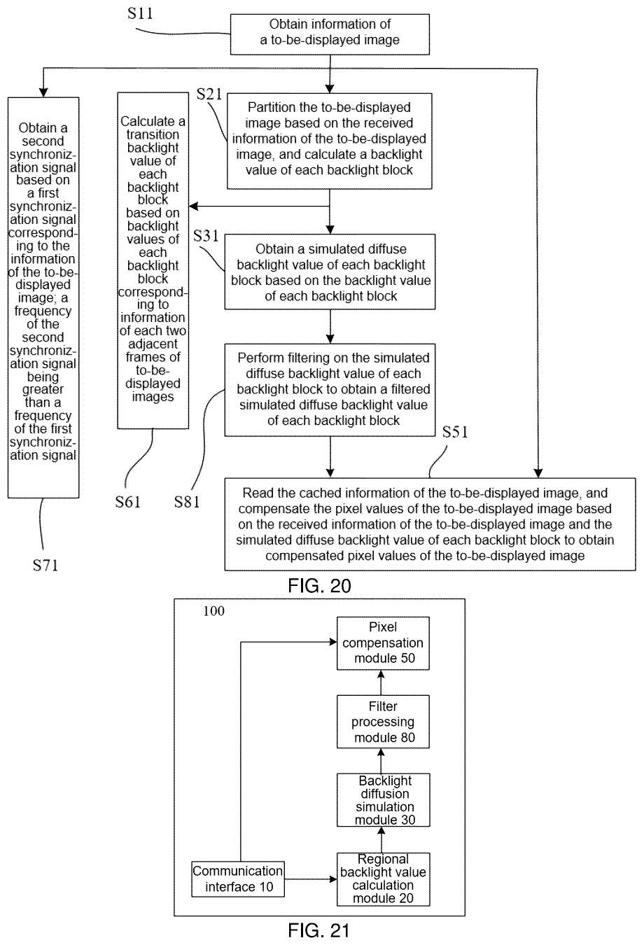

FIG. 20 is a flow diagram of an image display processing method, in accordance with some embodiments.

In some embodiments, referring to FIG. 20, the image display processing method further includes the following steps.

In S81, filtering is performed on the simulated diffuse backlight value of each backlight block to obtain a filtering simulated diffuse backlight value of each backlight block.

After step S31 and before step S51, step S81 may be used to perform filtering on the simulated diffuse backlight value of each backlight block obtained in step S31 to obtain a filtered simulated diffuse backlight value of each backlight block.

Based on this, step S51 may include: compensating pixel values of the to-be-displayed image according to the filtered simulated diffuse backlight values of all the backlight blocks and the read cached information of the to-be-displayed image, so as to obtain compensated pixel values of the to-be-displayed image.

Step S81 may be used to obtain the filtered simulated diffuse backlight value of each backlight block to reduce the difference in the filtered simulated diffuse backlight values of adjacent backlight blocks, thereby making the filtered simulated diffuse backlight values of adjacent backlight block transition smoothly, which may help reduce the generation of patch stripes and improve the display effect of the display panel 210.

It will be noted that the specific process of “performing filtering in step S81” is similar to step S81 in the image display processing method shown in FIG. 16 above, the description of step S81 may be referred to the description in FIG. 16 above, which will not be repeated here.

In addition, the above-described image display processing method may be applied to the image display processing apparatus 100 shown in FIGS. 17 and 18. For the detailed description of each of the above steps, reference will be made to the description of the image display processing apparatus 100 shown in FIGS. 17 and 18, which will not be repeated here.

It will be noted that, for the processes not described in detail in the description of the image display processing apparatus 100 shown in FIGS. 17 and 18, which may be referred to the description made in detail for the image display processing apparatus 100 shown in FIG. 11, and will not be repeated here.

FIG. 21 is a structural diagram of an imaging display processing apparatus, in accordance with some other embodiments.

In light of this, some embodiments of the present disclosure provide an imaging display processing apparatus 100. As shown in FIG. 21, the image display processing apparatus 100 includes a communication interface 10, a regional backlight value calculation module 20, a backlight diffusion simulation module 30, a filtering processing module 80, and a pixel compensation module 50.

The communication interface 10 is configured to receive in formation of a to-be-displayed image. The communication interface 10 is coupled to the regional backlight value calculation module 20, and the communication interface 10 is configured to transmit the received information of the to-be-displayed image to the regional backlight value calculation module 20.

The regional backlight value calculation module 20 is coupled to the communication interface 10. The regional backlight value calculation module 20 is configured to partition the image to be displayed based on the received information of the to-be-displayed image, and calculate the backlight value of each backlight block.

The backlight diffusion simulation module 30 is coupled to the regional backlight value calculation module 20. The backlight diffusion simulation module 30 is configured to obtain a simulated diffuse backlight value of each backlight block based on the backlight value of each backlight block.

The filter processing module 80 is coupled between the backlight diffusion simulation module 30 and the pixel compensation module 50. The filter processing module 80 is configured to: select a target backlight block from all the backlight blocks, the target backlight block and multiple backlight blocks around the target backlight block constituting a first matrix of n rows and n columns, and the first matrix being symmetrically arranged with the target backlight block as the center; obtain an average diffuse backlight value of each backlight block in the first matrix based on the diffuse backlight value of each backlight block in the first matrix; where n is a positive integer.

Based on this, multiple array-arranged backlight blocks may be combined into multiple first matrices Q1 to obtain the average diffuse backlight value corresponding to the first matrix Q1, so that the average diffuse backlight value corresponding to multiple backlight blocks within a region may be obtained. That is, the backlight values corresponding to all backlight blocks in the first matrix Q1 may be added together to obtain an average value, so as to obtain a corresponding average diffuse backlight value. Thus, the difference between the average diffuse backlight values corresponding to adjacent first matrices Q1 may be made small, so that the average diffuse backlight values corresponding to adjacent first matrices Q1 transition smoothly, which may help to ameliorate the problem of patchy stripes and improve the display effect of the display panel 210.

The pixel compensation module 50 is coupled to both the communication interface 10 and the filter processing module 80. The pixel compensation module 50 is configured to compensate the pixel values of the to-be-displayed image based on the received information of the to-be-displayed image and the average diffuse backlight value of each backlight block to obtain the compensated pixel values of the to-be-displayed image.

In summary, in the image display processing apparatus 100 provided in the embodiments of the present disclosure, the filter processing module 80 is utilized to performing filtering on the backlight values of all the backlight blocks to obtain the corresponding average diffuse backlight value, and transmit the corresponding average diffuse backlight value to the pixel compensation module 50. Subsequently, the pixel compensation module 50 compensates the pixel values of the to-be-displayed image based on the received information of the to-be-displayed image and the average diffuse backlight value of each backlight block to obtain the compensated pixel values of the to-be-displayed image, which may help reduce the generation of patch stripes and improve the display effect of the display panel 210.

It will be noted that, for the specific working principles and processes of the communication interface 10, the regional backlight value calculation module 20, the backlight diffusion simulation module 30, the filter processing module 80, and the pixel compensation module 50, reference may be made to the description in the above embodiments, which will not be repeated here.

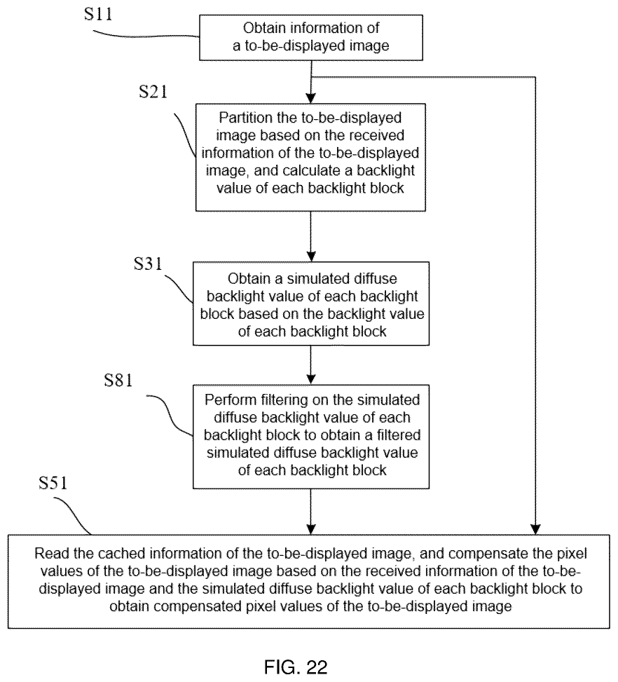

FIG. 22 is a flow diagram of an image display processing method, in accordance with some embodiments.

In some embodiments, as shown in FIG. 22, the image display processing method includes the following steps.

In S11, information of a to-be-displayed image is obtained. The to-be-displayed image is an image that the display panel currently needs to display, and the information of the to-be-displayed image may include a resolution of the to-be-displayed image, and image three-channel values of each pixel.

In S21, the to-be-displayed image is partitioned based on the received information of the to-be-displayed image, and a backlight value of each backlight block is calculated.

Step S21 may include the following steps.

In S211, the to-be-displayed image is partitioned based on the received information of the to-be-displayed image to obtain information of multiple image blocks.

In S212, a backlight value of a corresponding backlight block is calculated based on the information of an image block of the to-be-displayed image to obtain the backlight value of each backlight block. The number of pieces of information of the image blocks corresponds to the number of backlight blocks in a one-to-one manner; that is, information of one image block corresponds to the backlight value of one backlight block.

Based on this, the regional backlight value calculation module 20 may obtain the backlight value of the corresponding backlight block based on the information of different partitions of the to-be-displayed image, so that the backlight value of each backlight block may be used for driving separately.

In S31, a simulated diffuse backlight value of each backlight block is obtained based on the backlight value of each backlight block.

The light emitted from any backlight block will illuminate an adjacent backlight block, and various positions in the same backlight block are affected differently by the light diffusion of the adjacent backlight block.

Based on this, the actual backlight situation is simulated in step S31, thereby ameliorating the effect of light diffusion on the light emitted by the multiple backlight blocks of the backlight module 220 to alleviate the blocking phenomenon.

In S81, filtering is performed on the simulated diffuse backlight value of each backlight block to obtain a filtering simulated diffuse backlight value of each backlight block.

Performing filtering in step S81 includes:
S811a, selecting a target backlight block from all the backlight blocks, the target backlight block and multiple backlight blocks around the target backlight block constituting a first matrix with n rows and n columns; and
S812a, obtaining, based on the diffuse backlight value of each backlight block in the first matrix, an average diffuse backlight value of each backlight block in the first matrix, where n is a positive integer.

In step S51, based on the received information of the to-be-displayed image and the filtered simulated diffuse backlight value of each backlight block, the pixel values of the to-be-displayed image are compensated to obtain the compensated pixel values of the to-be-displayed image.

In addition, the above-described image display processing method may be applied to the image display processing apparatus 100 shown in FIG. 21. For the detailed description of each of the above steps, reference will be made to the description of the image display processing apparatus 100 shown in FIG. 21, which will not be repeated here.

It should be noted that, for the processes not described in detail of the image display processing apparatus 100 shown in FIG. 21, reference will be made to the processes described in detail of the image display processing apparatus 100 shown in FIG. 11, which will not be repeated here.

Some embodiments of the present disclosure provide a computer-readable storage medium (e.g., a non-transitory computer-readable storage medium), the computer-readable storage medium has stored a computer program instruction, and the computer program instruction, when executed on a computer (e.g., a display apparatus), causes the computer to perform the image display processing method according to any of the above embodiments.

For example, the computer-readable storage medium may include, but is not limited to, a magnetic storage device (e.g., a hard disk, a floppy disk or a magnetic tape), an optical disk (e.g., a compact disk (CD), a digital versatile disk (DVD), or a digital versatile disc), a smart card, a flash memory device (e.g., an erasable programmable read-only memory (EPROM), a card, a stick or a key driver). Various computer-readable storage media described in the present disclosure may represent one or more devices and/or other machine-readable storage media, which are used for storing information. The term “machine-readable storage media” may include, but be not limited to, wireless channels and various other media capable of storing, containing and/or carrying instructions and/or data.

Some embodiments of the present disclosure provide a computer program product; for example, the computer program product is stored in a non-transitory computer-readable storage medium. The computer program product includes a computer program instruction, and when executed on a computer (e.g., a display apparatus), the computer program instructions cause the computer to perform the image display processing method according to the above embodiments.

Some embodiments of the present disclosure provide a computer program. When executed on a computer (e.g., a display apparatus), the computer program causes the computer to perform the image display processing method according to the foregoing embodiments.

Beneficial effects of the computer-readable storage medium, the computer program product and the computer program are the same as the beneficial effects of the image display processing method as described in the above embodiments, and details will not be repeated here.

The above are only specific embodiments of the present disclosure, but the protection scope of the present disclosure is not limited thereto, and variations or substitutions that any person skilled in the art may conceive of within the technical scope disclosed by the present disclosure, should fall within the protection scope of the present disclosure. Therefore, the protection scope of the present disclosure should be determined by the protection scope of the claims.

1. An image display processing apparatus, comprising: a communication interface, a regional backlight value calculation module, a backlight diffusion simulation module, a storage module, and a pixel compensation module; wherein
the communication interface is configured to receive information of a to-be-displayed image;
the regional backlight value calculation module is coupled to the communication interface, and the regional backlight value calculation module is configured to: partition the to-be-displayed image based on the received information of the to-be-displayed image, and calculate a backlight value of each backlight block;
the backlight diffusion simulation module is coupled to the regional backlight value calculation module, and the backlight diffusion simulation module is configured to obtain a simulated diffuse backlight value of each backlight block based on the backlight value of each backlight block;
the storage module is coupled to the communication interface, and the storage module is configured to cache the information of the to-be-displayed image for a preset duration before the information of the to-be-displayed image is output; and
the pixel compensation module is coupled to both the storage module and the backlight diffusion simulation module; the pixel compensation module is configured to compensate pixel values of the to-be-displayed image based on the received information of the to-be-displayed image and the simulated diffuse backlight value of each backlight block to obtain compensated pixel values of the to-be-displayed image.

2. The image display processing apparatus according to claim 1, wherein the preset duration is substantially equal to a duration for the regional backlight value calculation module to partition the to-be-displayed image and to calculate backlight values of all backlight blocks.

3. The image display processing apparatus according to claim 1, further comprising:
a backlight data processing module coupled to the regional backlight value calculation module, wherein the backlight data processing module is configured to calculate a transition backlight value of each backlight block based on backlight values of each backlight block corresponding to information of each two adjacent frames of to-be-displayed images.

4. The image display processing apparatus according to claim 3, wherein the backlight data processing module includes a memory and an operator, and the memory includes a plurality of memory partitions;
the operator is coupled to the memory, and the operator is configured to calculate the transition backlight value of each backlight block based on the backlight values of each backlight block corresponding to the information of each two adjacent frames of to-be-displayed images; and
the memory is coupled to the regional backlight value calculation module and the operator, and the memory is configured to store a backlight value of each backlight block corresponding to information of each frame of to-be-displayed image, and store the received transition backlight value of each backlight block.

5. The image display processing apparatus according to claim 3, further comprising:
a synchronization signal generation module coupled to the communication interface, the synchronization signal generation module being configured to obtain a second synchronization signal based on a first synchronization signal corresponding to the information of the to-be-displayed image, wherein a frequency of the second synchronization signal is greater than a frequency of the first synchronization signal, so that the backlight data processing module outputs the transition backlight value of each backlight block between the backlight values of each backlight block corresponding to the information of each two adjacent frames of to-be-displayed images.

6. The image display processing apparatus according to claim 5, wherein the frequency of the second synchronization signal is three times the frequency of the first synchronization signal.

7. The image display processing apparatus according to claim 1, further comprising:
a filter processing module coupled between the backlight diffusion simulation module and the pixel compensation module, wherein the filter processing module is configured to: select a target backlight block from all backlight blocks, the target backlight block and multiple backlight blocks around the target backlight block constituting a first matrix of n rows and n columns; and obtain an average diffuse backlight value of all backlight blocks in the first matrix based on diffuse backlight values of all the backlight blocks in the first matrix; wherein n is a positive integer.

8. (canceled)

9. The image display processing apparatus according to claim 7, wherein the first matrix is symmetrically arranged with the target backlight block as a center.

10. The image display processing apparatus according to claim 7, wherein the filter processing module is further configured to supplement, in a case where the first matrix is not symmetrically arranged with the target backlight block as a center, the first matrix in a mirror manner to from a second matrix symmetrically arranged with the target backlight block as a center.

11. The image display processing apparatus according to claim 1, wherein the image display processing apparatus is a driver board.

12. An image display processing apparatus, comprising: a communication interface, a regional backlight value calculation module, a backlight data processing module, a synchronization signal generation module, a backlight diffusion simulation module, and a pixel compensation module; wherein
the communication interface is configured to receive information of a to-be-displayed image;
the regional backlight value calculation module is coupled to the communication interface, and the regional backlight value calculation module is configured to: partition the to-be-displayed image based on the received information of the to-be-displayed image, and calculate a backlight value of each backlight block;
the backlight data processing module is coupled to the regional backlight value calculation module, and the backlight data processing module is configured to calculate a transition backlight value of each backlight block based on backlight values of each backlight block corresponding to information of each two adjacent frames of the to-be-displayed images;
the synchronization signal generation module is coupled to the communication interface, and the synchronization signal generation module is configured to obtain a second synchronization signal based on a first synchronization signal corresponding to the information of the to-be-displayed image, wherein a frequency of the second synchronization signal is greater than a frequency of the first synchronization signal, so that the backlight data processing module outputs the transition backlight value of each backlight block between the backlight values of each backlight block corresponding to the information of each two adjacent frames of to-be-displayed images;
the backlight diffusion simulation module is coupled to the regional backlight value calculation module, and the backlight diffusion simulation module is configured to obtain a simulated diffuse backlight value of each backlight block based on the backlight value of each backlight block; and
the pixel compensation module is coupled to both the communication interface and the backlight diffusion simulation module; the pixel compensation module is configured to compensate pixel values of the to-be-displayed image based on the received information of the to-be-displayed image and the simulated diffuse backlight value of each backlight block to obtain compensated pixel values of the to-be-displayed image.

13. An image display processing apparatus, comprising: a communication interface, a regional backlight value calculation module, a backlight diffusion simulation module, a filter processing module, and a pixel compensation module; wherein
the communication interface is configured to receive information of a to-be-displayed image;
the regional backlight value calculation module is coupled to the communication interface, and the regional backlight value calculation module is configured to: partition the to-be-displayed image based on the received information of the to-be-displayed image, and calculate a backlight value of each backlight block;
the backlight diffusion simulation module is coupled to the regional backlight value calculation module, and the backlight diffusion simulation module is configured to obtain a simulated diffuse backlight value of each backlight block based on the backlight value of each backlight block;
the filter processing module is coupled between the backlight diffusion simulation module and the pixel compensation module, and the filter processing module is configured to: select a target backlight block from all backlight blocks, the target backlight block and multiple backlight block around the target backlight block constituting a first matrix of n rows and n columns, and the first matrix being symmetrically arranged with the target backlight block as a center; and obtain an average diffuse backlight value of all backlight blocks in the first matrix based on diffuse backlight values of all the backlight blocks in the first matrix, wherein n is a positive integer; and
the pixel compensation module is coupled to both the communication interface and the filter processing module; the pixel compensation module is configured to compensate pixel values of the to-be-displayed image based on the received information of the to-be-displayed image and the average diffuse backlight value of all the backlight blocks to obtain compensated pixel values of the to-be-displayed image.

14. A display apparatus, comprising: a display panel, a backlight module, and the image display processing apparatus according to claim 1; wherein
the display panel is coupled to the image display processing apparatus, and is configured to receive the compensated pixel values of the to-be-displayed image from the image display processing apparatus, and display the to-be-displayed image; and
the backlight module is coupled to the image display processing apparatus and is configured to receive the backlight value of each backlight block from the image display processing apparatus to drive the backlight module to emit light.

15. An image display processing method, applied to the image display processing apparatus according to claim 1, the method comprising:
obtaining the information of the to-be-displayed image;
partitioning the to-be-displayed image based on the received information of the to-be-displayed image, and calculating the backlight value of each backlight block;
obtaining the simulated diffuse backlight value of each backlight block based on the backlight value of each backlight block;
caching the information of the to-be-displayed image for a preset duration; and
reading the cached information of the to-be-displayed image, and compensating the pixel values of the to-be-displayed image based on the received information of the to-be-displayed image and the simulated diffuse backlight value of each backlight block to obtain the compensated pixel values of the to-be-displayed image.

16. The image display processing method according to claim 15, wherein the preset duration is substantially equal to a duration for the regional backlight value calculation module to partition the to-be-displayed image and to calculate the backlight value of each backlight block.

17. The image display processing method according to claim 15, further comprising:
calculating a transition backlight value of each backlight block based on backlight values of each backlight block corresponding to information of each two adjacent frames of to-be-displayed images.

18. The image display processing method according to claim 17, further comprising:
obtaining a second synchronization signal based on a first synchronization signal corresponding to the information of the to-be-displayed image; wherein a frequency of the second synchronization signal is greater than a frequency of the first synchronization signal, so as to output the transition backlight value of each backlight block between the backlight values of each backlight block corresponding to the information of each two adjacent frames of to-be-displayed images; and
reading, under control of the second synchronization signal, the backlight value of each backlight block corresponding to the information of the former frame of to-be-displayed images in each two adjacent frames, the transition backlight value of each backlight block, and the backlight value of each backlight block corresponding to the information of the latter frame of to-be-displayed image in each two adjacent frames sequentially.

19. The image display processing method according to claim 15, further comprising:
performing filtering on the simulated diffuse backlight value of each backlight block to obtain a filtered simulated diffuse backlight value of each backlight block; wherein
compensating the pixel values of the to-be-displayed image based on the simulated diffuse backlight value of each backlight block and the read cached information of the to-be-displayed image to obtain the compensated pixel values of the to-be-displayed image includes:
compensating the pixel values of the to-be-displayed image based on the filtered simulated diffuse backlight value of each backlight block and the read cached information of the to-be-displayed image to obtain the compensated pixel values of the to-be-displayed image.

20. The image display processing method according to claim 19, wherein performing filtering includes:
selecting a target backlight area from all backlight blocks, the target backlight block and multiple backlight blocks around the target backlight block constituting a first matrix with n rows and n columns; and obtaining an average diffuse backlight value of all backlight blocks in the first matrix based on diffuse backlight values of all the backlight blocks in the first matrix;
wherein n is a positive integer.

21-22. (canceled)

23. A computer-readable storage medium, wherein the computer-readable storage medium has stored therein computer program instructions, and the computer program instructions, when run on a display apparatus, cause the display apparatus to perform the image display processing method according to claim 15.
